(19) United States
(12) Patent Application Publication
(10) Pub. No.: US 2019/0198214 A1
(43) Pub. Date: Jun. 27, 2019

(54) REACTOR

(71) Applicants: EGUCHI HIGH FREQUENCY CO., LTD., Tokyo (JP); NIPPON STEEL & SUMITOMO METAL CORPORATION, Tokyo (JP)

(72) Inventors: Kazuya TSURUSAKI, Tokyo (JP); Yohei EGUCHI, Tokyo (JP); Yasuhiro MAYUMI, Tokyo (JP)

(73) Assignees: EGUCHI HIGH FREQUENCY CO., LTD., Tokyo (JP); NIPPON STEEL & SUMITOMO METAL CORPORATION, Tokyo (JP)

(21) Appl. No.: 16/322,280

(22) PCT Filed: Sep. 19, 2017
(86) PCT No.: PCT/JP2017/033663

§ 371 Date: Jan. 31, 2019

(30) Foreign Application Priority Data
Oct. 31, 2016 (JP) 2016-213314

(51) Int. Cl. H01F 17/00; H01F 21/00; H01F 27/28; H01F 37/00; H01F 27/00

(52) U.S. Cl. CPC H01F 17/0006; H01F 21/00; H01F 2027/2809; H01F 37/00; H01F 27/006; H01F 27/2804

(57) ABSTRACT

Ring-shaped moving holes (2a to 2d) are formed on a first supporting member (2), and holes (4a to 4d) are formed on a second supporting member (4). A first coil (1) is rotated along the moving holes (2a to 2d) in a state where supports (5a to 5d) and bolts (6a to 6d) are inserted in the moving holes (2a to 2d) and the holes (4a to 4d). The first coil (1) and a second coil (3) are fixed so that coil surfaces of the first coil (1) and the second coil (3) become parallel by using the supports (5a to 5d), the bolts (6a to 6d), and nuts (7a to 7d).

### TECHNICAL FIELD

The present invention relates to a reactor, and is suitable when used for an electric circuit, in particular.

### BACKGROUND ART

The needs for reducing the emission of greenhouse effect gas such as carbon dioxide have been high up to now in order to prevent global warming. For example, in the field of steel, operating an induction heating device intended for performing heating at high frequencies with high efficiency has been achieved. Further, the introduction of induction heating devices as an alternative technique to a gas heating furnace whose heating efficiency is poor has been increasing recently. Further, in the field of automobiles and physical distributions, the development of a technique to feed power in a non-contact manner as a power feeding unit with respect to a movable body such as an electric vehicle and a crane has been in progress.

These common techniques are a technique in which a capacitor (electrostatic capacitance C) and a load coil (inductance L) are connected in series or parallel to a high frequency generating device to generate voltage resonance or current resonance. In these techniques, it is possible to heat an object to be heated in a non-contact manner by magnetic fluxes generated when a resonant current flows through the load coil. Further, in these techniques, it is possible to feed power in a non-contact manner by utilizing an electromagnetic induction phenomenon based on the magnetic fluxes generated when the resonant current flows through the load coil. Note that the resonant current indicates a current whose frequency is a resonance frequency.

In the case of utilizing the resonance phenomenon as above, if the capacitor (electrostatic capacitance C) and the heating coil/load coil (inductance L) are determined, the frequency (resonance frequency) in the high frequency generating device is determined unambiguously.

In a resonant circuit, an electrostatic capacitance C, an inductance L, and a resistance R of a load circuit become elements to determine a load impedance. For this reason, it also becomes necessary to achieve a balance of respective numeric values of the electrostatic capacitance C and the inductance L.

There is a case where an operating frequency of the high frequency generating device does not become a resonance frequency depending on the magnitude of the inductance L of these heating coils/load coils. In such a case, it is often the case that a reactor for supplying a fixed inductance is separately added and installed to be used in an electric circuit that configures the high frequency generating device.

As a reactor as an inductance element to be added and installed in an electric circuit, there are an air-core reactor which does not use a core, and a reactor using a core. As a technique regarding such reactors, there are techniques described in Patent Literatures 1 to 6.

Patent Literature 1 discloses a means of holding and fixing an air-core reactor as a countermeasure against a vibration caused by an electromagnetic force of an air-core reactor. Concretely, in the technique described in Patent Literature 1, two or more bars are made to pass through the air-core reactor. These two or more bars are fixed to L-shaped supports.

Patent Literature 2 discloses a means of relaxing an electric field of a high frequency reactor utilizing a core as a countermeasure against a corona discharge generated under a high voltage from the high frequency reactor. Concretely, in the technique described in Patent Literature 2, a core is configured by a plurality of core blocks arranged in a state where an interval is provided therebetween in a longitudinal direction. An upper end of the core is fixed by a conductive upper fixing plate. A lower end of the core is fixed by a conductive lower fixing plate. The lower fixing plate is connected to a base via insulators. A distance between the base and the lower fixing plate is set to be larger than a gap among the core blocks.

Patent Literature 3 discloses a technique of adjusting an inductance L by changing relative positions between two coils as a technique relating to a high frequency electronic circuit arranged on a substrate. Concretely, in the technique described in Patent Literature 3, two coils having the same shape are used. A gap between the two coils is changed, or the two coils are rotated about ends of the coils made as a shaft or opened/closed, and thereby a rotation angle or opening/closing angle of the coils is changed.

Patent Literature 4 discloses a means of realizing a small-sized transformer by utilizing a technique of changing an inductance by changing an overlapped area or a mutual distance of two inductors arranged on a printed circuit board.

Patent Literature 5 discloses a means of enlarging a frequency range of an oscillator by switching the series-parallel connection of two inductors integrated on a semiconductor chip.

Patent Literature 6 discloses that shapes and positions of two inductors developed on a semiconductor chip are decided to reduce an EM (electromagnetic) coupling between resonators.

Further, Patent Literatures 5 and 6 disclose that two inductors are configured by 8-shaped inductors or four-leaf clover-shaped inductors.

### CITATION LIST

### Patent Literature

Patent Literature 1: Japanese Laid-open Patent Publication No. 2014-45110

Patent Literature 2: Japanese Patent No. 5649231

Patent Literature 3: Japanese Laid-open Patent Publication No. 58-147107

Patent Literature 4: Japanese Laid-open Patent Publication No. 2014-212198

Patent Literature 5: Japanese Patent No. 5154419

Patent Literature 6: Japanese Translation of PCT International Application Publication No. JP-T-2007-526642

### SUMMARY OF INVENTION

### Technical Problem

In a resonant circuit, a required inductance is previously set based on a resonance frequency of the circuit. An inductance of a reactor which is installed in the resonant circuit is designed and manufactured based on a value which is previously set with respect to the resonant circuit as a target.

However, when manufacturing a reactor, a coil is formed by winding of a copper tube or a conductor. Further, when manufacturing a reactor having cores, a gap material made of a nonmagnetic material is inserted between the cores, for example. The reactor is manufactured through an assembling work such that the coils are attached to the cores in which the gap material is inserted. Therefore, there is generated not a little difference between an inductance value realized in the manufactured and assembled reactor and a design value.

An inductance of an air-core reactor is changed by a diameter, a radius of turn (equivalent radius), the number of turns, and the entire length of a wound coil, and a magnetic shielding situation around the reactor or the like.

Further, an inductance of a reactor having cores is influenced by, not only the factors as above which exert an influence on the inductance of the air-core reactor, but also a gap between the cores. Further, the inductance of the reactor having the cores is also changed by a frequency, a voltage, and a current applied to a coil.

In the techniques described in Patent Literatures 1 and 2, the inductance of the reactor is fixed. Therefore, there is a need to adjust the inductance of the reactor in a manner as follows. First, the reactor is manufactured and assembled temporarily. Next, a frequency, a voltage, and a current which are required in terms of specification are applied to the manufactured and temporarily assembled reactor to measure an inductance of the manufactured and temporarily assembled reactor. Generally, it is rarely that an inductance of a reactor having a large size due to its structure and to which a high-frequency large current is applied falls within a range of an inductance required in terms of specification, by one time of the manufacture and temporary assembly. When the inductance of the reactor does not fall within the range of the inductance required in terms of specification, the reactor is disassembled and adjusted for minimizing a deviation between the measured value of the inductance and the target value, and then the inductance is measured again.

Concretely, in order to increase an inductance in an air-core reactor, a measure is taken such that the entire coil length is shortened or the number of turns of a coil is increased. Further, in order to increase an inductance in a reactor having cores, a measure is taken such that a gap between the cores is reduced or the number of turns of a coil is increased. In order to reduce the inductance, a measure opposite to the above-described measures for increasing the inductance is taken.

Further, it takes time to adjust the inductance of the manufactured and temporarily assembled reactor described above. Depending on circumstances, there is a case where the manufacture and the temporary assembly of the reactor are repeated a plurality of times to adjust the inductance of the reactor. In such a case, it takes a lot of time to adjust the inductance of the reactor.

Further, when a value of an inductance required in a certain electric circuit is determined, a reactor having the inductance is designed and manufactured. With respect to an electric circuit with a frequency and a current same as those of the electric circuit but with an inductance different from that of the electric circuit, there is a need to separately design and manufacture a reactor having the inductance required in that electric circuit. As described above, it is necessary to design, manufacture, and adjust a reactor which satisfies the required specification of the inductance each time or every stage of the inductance.

For example, when a reactor having a specification value of current of 1000 [A] and a specification value of frequency of 20 [kHz] is employed, if a specification value of inductance is different, there is a need to design, manufacture, and adjust reactors one by one for each of different specification values.

Accordingly, as a technique regarding a reactor in which an inductance is variable, there are techniques described in Patent Literatures 3 and 4. However, the technique described in Patent Literature 3 is a technique regarding a high frequency electronic circuit used on a printed circuit board. Therefore, it is not easy to make a large current flow through this high frequency electronic circuit. Further, the technique described in Patent Literature 4 employs a spiral inductor used in an IC as a premise. Therefore, it is not easy to make a large current flow through this IC. Further, in both of the techniques described in Patent Literatures 3 and 4, an adjustment range of the inductance is limited.

Further, the techniques described in Patent Literatures 5 and 6 are techniques regarding an inductor manufactured on a semiconductor chip which deals with a minute current. Besides, in the techniques described in Patent Literatures 5 and 6, when the inductor is manufactured, it is not possible to adjust the inductance afterward. Therefore, when there is a need to change the inductance at a stage of design or after the manufacture of the inductor, it inevitably takes time and cost.

The present invention has been made based on the above-described problems, and an object thereof is to provide a reactor capable of easily changing an inductance in a wide range according to a wide variety of specifications.

### Solution to Problem

A reactor of the present invention is a reactor capable of varying an inductance as a constant of an electric circuit, the reactor including: a first coil having a first circumferential portion, a second circumferential portion, and a first connecting portion; a second coil having a third circumferential portion, a fourth circumferential portion, and a second connecting portion; a first supporting member supporting the first coil; a second supporting member supporting the second coil; and a holding member holding the first coil and the second coil, in which the first circumferential portion, the second circumferential portion, the third circumferential portion, and the fourth circumferential portion each are a portion circling so as to surround an inner region thereof, the first connecting portion is a portion that connects one end of the first circumferential portion and one end of the second circumferential portion mutually, the second connecting portion is a portion that connects one end of the third circumferential portion and one end of the fourth circumferential portion mutually, the first coil and the second coil are connected in series or parallel, the first circumferential portion and the second circumferential portion exist on the same plane, the third circumferential portion and the fourth circumferential portion exist on the same plane, a set of the first circumferential portion and the second circumferential portion and a set of the third circumferential portion and the fourth circumferential portion are arranged in a parallel state with an interval provided therebetween, both or one of the first coil and the second coil performs both or one of a rotation about an axis of the first coil and the second coil as a rotation axis and a parallel movement in a direction perpendicular to the axis, the axis is an axis passing through a middle position between a center of the first circumferential portion and a center of the second circumferential portion and a middle position between a center of the third circumferential portion and a center of the fourth circumferential portion, the holding member is made of one or a plurality of members and it makes the set of the first circumferential portion and the second circumferential portion and the set of the third circumferential portion and the fourth circumferential portion become parallel with the interval provided therebetween and prevents the first coil and the second coil after performing both or one of the rotation and the parallel movement from moving.

### BRIEF DESCRIPTION OF DRAWINGS

FIG. 1 is a diagram illustrating one example of a configuration of a reactor of a first embodiment.

FIG. 2A is a diagram illustrating one example of a configuration of a first coil and a first supporting member of the first embodiment.

FIG. 2B is a diagram illustrating one example of a configuration of a second coil and a second supporting member of the first embodiment.

FIG. 3A is a diagram illustrating the first coil in a certain state and the first coil in a state of being rotated by 180[°] from the certain state in an overlapping manner.

FIG. 3B is a diagram illustrating the second coil in a certain state and the second coil in a state of being rotated by 180[°] from the certain state in an overlapping manner.

FIG. 4 is a diagram illustrating one example of a positional relationship between the first coil and the second coil of the first embodiment.

FIG. 5A is a diagram illustrating a first example of directions of magnetic fluxes generated in the first coil and the second coil of the first embodiment, together with circuit symbols of the first coil and the second coil.

FIG. 5B is a diagram illustrating a second example of directions of magnetic fluxes generated in the first coil and the second coil of the first embodiment, together with circuit symbols of the first coil and the second coil.

FIG. 6A is a diagram illustrating the first example of the magnetic fluxes generated in the first coil and the second coil of the first embodiment, together with the first coil and the second coil in a state of being arranged in the reactor.

FIG. 6B is a diagram illustrating the second example of the magnetic fluxes generated in the first coil and the second coil of the first embodiment, together with the first coil and the second coil in a state of being arranged in the reactor.

FIG. 7 is a diagram explaining one example of an adjusting method of the positional relationship between the first coil and the second coil of the first embodiment.

FIG. 8A is a diagram illustrating a modified example of moving holes of the first embodiment.

FIG. 8B is a diagram explaining a modified example of the adjusting method of the positional relationship between the first coil and the second coil of the first embodiment.

FIG. 9 is a diagram illustrating a modified example of the reactor of the first embodiment.

FIG. 10A is a diagram illustrating a first modified example of the configuration of the first coil and the first supporting member of the first embodiment.

FIG. 10B is a diagram illustrating a first modified example of the configuration of the second coil and the second supporting member of the first embodiment.

FIG. 11A is a diagram illustrating a second modified example of the configuration of the first coil and the first supporting member of the first embodiment.

FIG. 11B is a diagram illustrating a second modified example of the configuration of the second coil and the second supporting member of the first embodiment.

FIG. 12A is a diagram illustrating one example of a configuration of a first coil and a first supporting member of a second embodiment.

FIG. 12B is a diagram illustrating one example of a configuration of a second coil and a second supporting member of the second embodiment.

FIG. 13 is a diagram illustrating one example of a positional relationship between the first coil and the second coil of the second embodiment.

FIG. 14 is a diagram illustrating one example of a configuration of a first coil and a first supporting member of a third embodiment.

FIG. 15 is a diagram illustrating a first example of a configuration of a reactor of a fourth embodiment.

FIG. 16A is a diagram illustrating a first example of a configuration of a first coil and a first supporting member of the fourth embodiment.

FIG. 16B is a diagram illustrating a first example of a configuration of a second coil and a second supporting member of the fourth embodiment.

FIG. 17 is a diagram illustrating a second example of the configuration of the reactor of the fourth embodiment.

FIG. 18A is a diagram illustrating a second example of the configuration of the first coil and the first supporting member of the fourth embodiment.

FIG. 18B is a diagram illustrating a second example of the configuration of the second coil and the second supporting member of the fourth embodiment.

FIG. 19A is a diagram illustrating one example of a configuration of a first coil and a first supporting member of a fifth embodiment.

FIG. 19B is a diagram illustrating one example of a configuration of a second coil and a second supporting member of the fifth embodiment.

### DESCRIPTION OF EMBODIMENTS

Hereinafter, embodiments of the present invention will be explained while referring to the drawings.

### First Embodiment

First, a first embodiment will be explained.

<Configuration of Reactor>

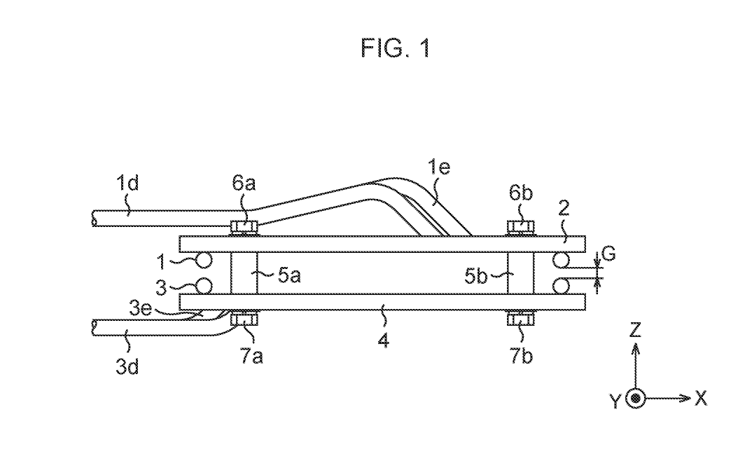

FIG. 1 is a diagram illustrating one example of a configuration of a reactor of the present embodiment. Note that X, Y, and Z coordinates illustrated in each drawing indicate the relationship of directions in each drawing. The mark of ● added inside ◯ indicates the direction from the far side of the sheet toward the near side. The mark of x added inside ◯ indicates the direction from the near side of the sheet toward the far side.

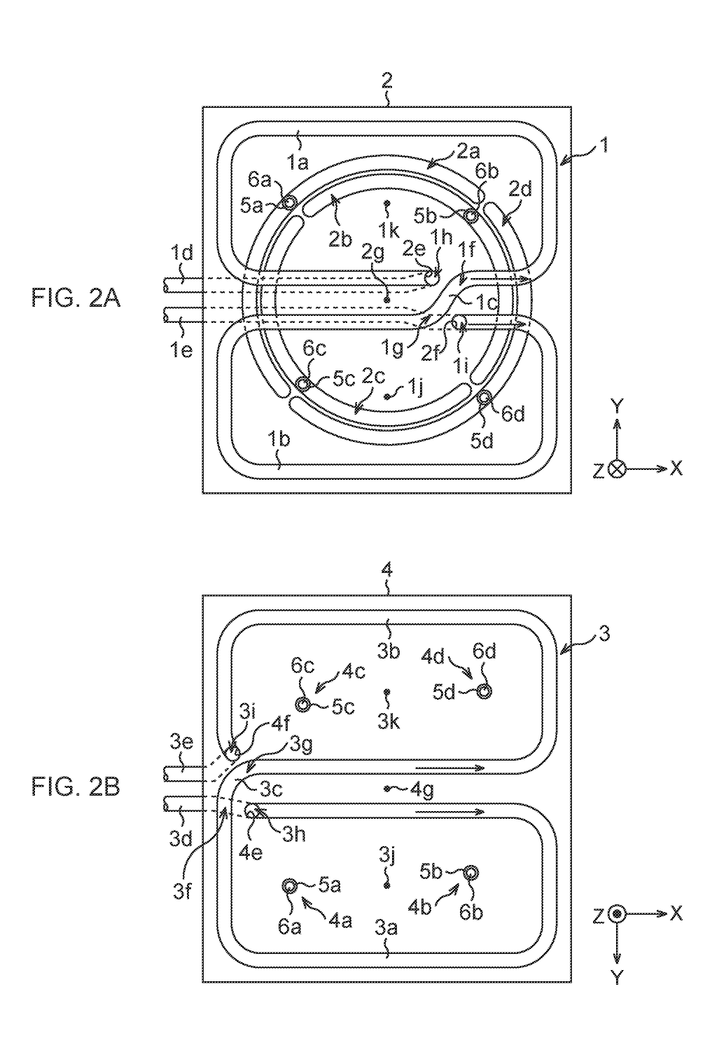

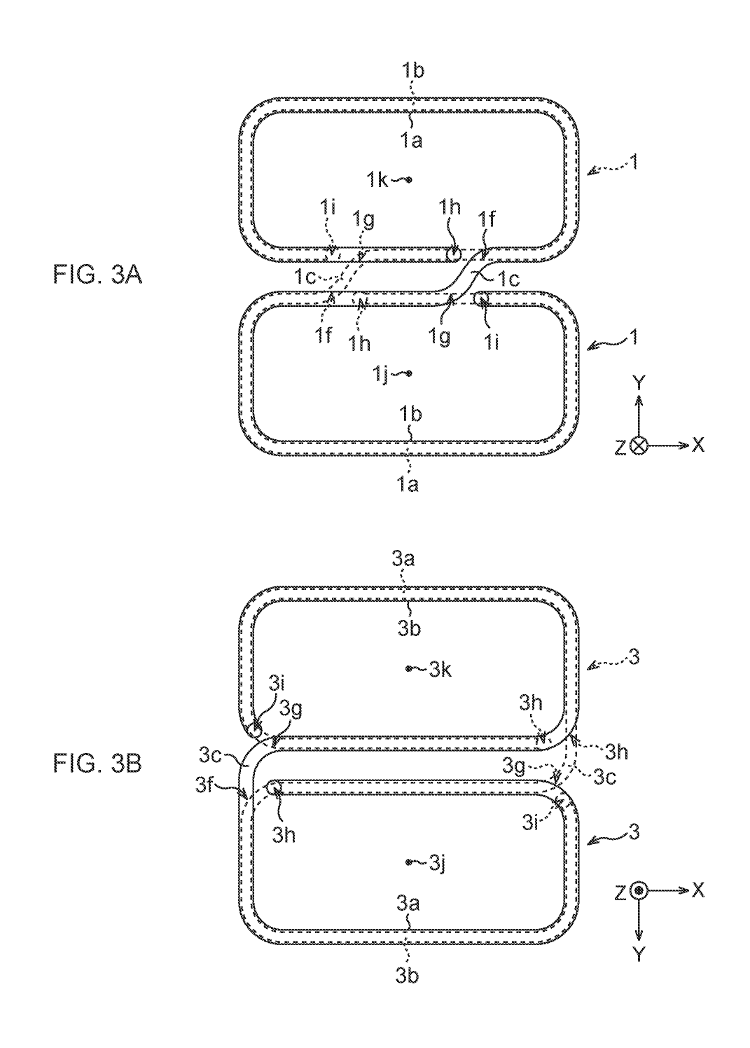

FIG. 1 is a diagram illustrating the configuration of the reactor of the present embodiment. FIG. 2A is a diagram illustrating one example of a configuration of a first coil 1 and a first supporting member 2. FIG. 2B is a diagram illustrating one example of a configuration of a second coil 3 and a second supporting member 4. FIG. 3A is a diagram illustrating the first coil 1 in a certain state and the first coil 1 in a state of being rotated by 180[°] from the certain state in an overlapping manner. In FIG. 3A, for convenience of illustration, one of these two first coils 1 is illustrated by a solid line, and the other of them is illustrated by a dotted line. FIG. 3B is a diagram illustrating the second coil 3 in a certain state and the second coil 3 in a state of being rotated by 180[°] from the certain state in an overlapping manner. Also in FIG. 3B, similarly to FIG. 3A, one of these two second coils 3 is illustrated by a solid line, and the other of them is illustrated by a dotted line, for convenience of illustration. Note that the second coil 3 does not rotate as will be described later, but, in FIG. 3B, the second coil 3 is assumed to rotate.

Each of FIG. 2A and FIG. 3A is a diagram where a surface of the first supporting member 2 facing the second supporting member 4 is seen along the Z-axis in FIG. 1. Each of FIG. 2B and FIG. 3B is a diagram where a surface of the second supporting member 4 facing the first supporting member 2 is seen along the Z-axis in FIG. 1.

The reactor of the present, embodiment is a reactor capable of varying an inductance as a constant of an electric circuit. In FIG. 1, FIG. 2A, and FIG. 2B, the reactor of the present embodiment has the first coil 1, the first supporting member 2, the second coil 3, the second supporting member 4, supports 5a to 5d, bolts 6a to 6d, and nuts 7a to 7d. Although the illustrations of nuts corresponding to the bolts 6c, 6d are omitted for convenience of illustration, the nuts corresponding to the bolts 6c, 6d are also arranged similarly to the nuts 7a, 7b corresponding to the bolts 6a, 6b. Hereinafter, the nuts corresponding to the bolts 6c, 6d are described as the nuts 7c, 7d, although the illustrations thereof are omitted for convenience of explanation.

First, the first coil 1 and the first supporting member 2 will be explained.

The first supporting member 2 is a member for supporting the first coil 1. The first coil 1 is fixed to the first supporting member 2. Holes 2e, 2f are holes through which the first coil 1 is led out to the outside.

The first supporting member 2 and the second supporting member 4 to be described later are fixed by the bolts 6a to 6d and the nuts 7a to 7d via the supports 5a to 5d so that an interval G between the first coil 1 and the second coil 3 to be described later can be kept constant. As illustrated in FIG. 2A, moving holes 2a to 2d intended for attaching the first supporting member 2 to the second supporting member 4, are formed on the first supporting member 2. The moving holes 2a to 2d are holes which enable the first supporting member 2 attached to the second supporting member 4 to rotate.

In the present embodiment, a planar shape of each of the moving holes 2a to 2d is an arc shape. The moving holes 2a, 2d are arranged so as to be along an arc of a first virtual circle. The moving holes 2b, 2c are positioned further on the center side of the first supporting member 2 relative to the moving holes 2a, 2d. The moving holes 2b, 2c are arranged so as to be along an arc of a second virtual circle whose radius is smaller than that of the first virtual circle and which is concentric with the first virtual circle. The first coil 1 can rotate even in a state where the supports 5a to 5d and the bolts 6a to 6d are passed through the moving holes 2a to 2d illustrated in FIG. 2A and positions of the supports 5a to 5d and the bolts 6a to 6d are fixed. The first coil 1 is rotated to decide the position of the first coil 1, and then the nuts 7a to 7d are used to fix the first coil 1 at that position, which stops the rotation of the first coil 1. In the present embodiment, an axis (rotation axis) of the first coil 1 is an axis passing through a center 2g of the first supporting member 2 and in a direction perpendicular to a surface of the first supporting member 2 (in the Z-axis direction).

As illustrated in FIG. 2A, the planar shape of the first supporting member 2 is square. The first supporting member 2 is formed of an insulating and non-magnetic material that has strength capable of supporting the first coil 1 so as to prevent the position of the first coil 1 in the Z-axis direction from changing. However, the planar shape of the supporting member 2 of the first coil 1 is not limited to square. The planar shape of the supporting member 2 of the first coil 1 may be rectangle or circle, for example. The first supporting member 2 is formed by using a glass laminated epoxy resin, a thermosetting resin, or the like, for example.

In FIG. 2A, the first coil 1 has a first circumferential portion 1a, a second circumferential portion 1b, a first connecting portion 1c, a first lead-out portion 1d, and a second lead-out portion 1e. The first circumferential portion 1a, the second circumferential portion 1b, the first connecting portion 1c, the first lead-out portion 1d, and the second lead-out portion 1e are integrated.

In the present embodiment, the number of turns of the first coil 1 is one [turn]. Further, in the present embodiment, a case where a figure of 8 in Arabic numerals is formed by the first circumferential portion 1a, the second circumferential portion 1b, and the first connecting portion 1c will be explained as an example. Note that in FIG. 3A, illustrations of the first lead-out portion 1d and the second lead-out portion 1e are omitted for convenience of illustration. Further, in FIG. 3A, the reference numerals and symbols are added to each of the two first coils 1 illustrated in an overlapping manner.

The first circumferential portion 1a is a portion circling so as to surround an inner region thereof. The second circumferential portion 1b is also a portion circling so as to surround an inner region thereof. The first circumferential portion 1a and the second circumferential portion 1b are arranged on the same horizontal plane (X-Y plane). Note that the first circumferential portion 1a and the second circumferential portion 1b do not necessarily have to be arranged on the same horizontal plane in a strict manner, and it is possible to say that they are arranged on the same horizontal plane within a design tolerance range, for example. The same applies to the “same horizontal plane” in the explanation below.

The first connecting portion 1c is a portion that connects a first end if of the first circumferential portion 1a and a first end 1g of the second circumferential portion 1b mutually, and is a non-circumferential portion.

The first lead-out portion 1d is connected to a second end 1h of the first circumferential portion 1a. The second end 1h of the first circumferential portion 1a is at a position of the hole 2e. The second lead-out portion 1e is connected to a second end 1i of the second circumferential portion 1b. The second end 1i of the second circumferential portion 1b is at a position of the hole 2f.

The first lead-out portion 1d and the second lead-out portion 1e become lead-out wires for connecting the first coil 1 to the outside. In FIG. 2A, each of the first lead-out portion 1d and the second lead-out portion 1e is illustrated by a dotted line, to thereby indicate that the first lead-out portion 1d and the second lead-out portion 1e exist on a surface opposite to the surface of the first supporting member 2 illustrated in FIG. 2A.

In FIG. 3A, the first coil 1 is brought into a state illustrated by a dotted line from a state illustrated by a solid line when being rotated by 180[°].

As illustrated in FIG. 2A, the center 2g of the first supporting member 2 (rotation axis) is positioned in the middle of a center 1k of the first circumferential portion 1a and a center 1j of the second circumferential portion 1b. The first circumferential portion 1a and the second circumferential portion 1b are positioned on the sides opposite to each other across the center 2g of the first supporting member 2 (the rotation axis of the first coil 1). Specifically, the first circumferential portion 1a and the second circumferential portion 1b are arranged so as to maintain a state where they are displaced by 180[°] in terms of angle in a direction in which the first coil 1 rotates. This angle is an angle formed by a virtual straight line mutually connecting the center 2g of the first supporting member 2 (rotation axis) and the center 1k of the first circumferential portion 1a at the shortest distance and a virtual straight line mutually connecting the center 2g of the first supporting member 2 and the center 1j of the second circumferential portion 1b at the shortest distance. Note that in FIG. 2A, the center 2g of the first supporting member 2, the center 1k of the first circumferential portion 1a, and the center 1j of the second circumferential portion 1b are points illustrated virtually, and are not existent points.

It is most preferable that the first circumferential portion 1a, the second circumferential portion 1b, a third circumferential portion 3a, and a fourth circumferential portion 3b have perfectly the same shape and size. However, as illustrated in FIG. 2A and FIG. 2B, it is sometimes impossible to make the first circumferential portion 1a, the second circumferential portion 1b, the third circumferential portion 3a, and the fourth circumferential portion 3b have perfectly the same shape and size.

Unless the state of magnetic fluxes penetrating the inside of each of the first circumferential portion 1a, the second circumferential portion 1b, the third circumferential portion 3a, and the fourth circumferential portion 3b greatly differs from that in the case where the first circumferential portion 1a, the second circumferential portion 1b, the third circumferential portion 3a, and the fourth circumferential portion 3b have perfectly the same shape and size when the alternating current is applied to the first coil 1 and the second coil 3, the first circumferential portion 1a, the second circumferential portion 1b, the third circumferential portion 3a, and the fourth circumferential portion 3b do not need to have perfectly the same shape and size.

The present inventors changed the sizes of the first coil and the second coil, the gap (interval in the Z-axis direction) between the first coil and the second coil, the shapes of the first coil and the second coil, and so on regarding various reactors including reactors in first to fifth embodiments, to measure variable magnifications β defined by an equation (2) to be described later. Note that the shapes and the sizes of the first circumferential portion, the second circumferential portion, the third circumferential portion, and the fourth circumferential portion were set to be perfectly the same. As a result of this, a range of the variable magnification β was about 2.3 to 5.6 magnifications. A range of a coupling coefficient k corresponding to this range becomes about 0.4 to 0.7. Note that the coupling coefficient k is expressed by the following equation (1).

M=±k\sqrt{ }(L1·L2) (1)

Here, M indicates a mutual inductance of the first coil 1 and the second coil 3. L1 is a self-inductance of the first coil 1. L2 is a self-inductance of the second coil 3. The coupling coefficient k is determined by the shapes, sizes, and relative positions of the first coil 1 and the second coil 3, and a relationship of 0≤k≤1 is established. k=1 indicates a case where there is no leakage flux, but, the leakage flux occurs actually, so that the coupling coefficient k becomes a value of less than 1.

Accordingly, as a value of a standard coupling coefficient ks between the first coil and the second coil, an average value in this range (=0.55 (=(0.4+0.7)÷2)) is employed. This standard coupling coefficient ks becomes a representative value of the coupling coefficient in the case where the first circumferential portion, the second circumferential portion, the third circumferential portion, and the fourth circumferential portion are perfectly the same in shape and size.

Here, a minimum value βmin of the variable magnification β of a combined inductance GL when seen from an alternating-current power supply circuit is assumed to be 2.0. The variable magnification β of the combined inductance GL when seen from the alternating-current power supply circuit is expressed by the following equation (2). Note that the combined inductance GL is an inductance evaluated from the alternating-current power supply circuit side as an inductance combined by the connection between the first coil 1 and the second coil 3.

β=(2L+2M)÷(2L−2M)=(2L+2kL)÷(2L−2kL)=(1+k)÷(1−k) (2)

Note that in order to simplify explanation here, the self-inductances L1, L2 of the first coil 1 and the second coil 3 are set to L (L1=L2=L).

When the minimum value βmin (=2.0) of the variable magnification β is substituted in the equation (2), a minimum value kmin of the coupling coefficient between the first coil and the second coil becomes about 0.33. When the minimum value kmin (=0.33) of the coupling coefficient is divided by the standard coupling coefficient ks (=0.55), 0.6 (=0.33/0.55) is obtained. Specifically, in order to secure the minimum value βmin (=2.0) of the variable magnification β, 0.33 is required as the minimum value kmin of the coupling coefficient. In order to achieve 0.33 as the minimum value kmin of the coupling coefficient, the shapes and the sizes of the first circumferential portion, the second circumferential portion, the third circumferential portion, and the fourth circumferential portion are only required to be the same in a portion of 60[%] of the entire length of these. Further, the minimum value βmin of the variable magnification β is preferably 2.5, and more preferably 3.0 practically. In order to correspond to this, from a result of calculation similar to that described above, the shapes and the sizes of the first circumferential portion, the second circumferential portion, the third circumferential portion, and the fourth circumferential portion are preferably the same in a portion of 78[%] of the entire length of these, and more preferably the same in a region of 91[%] or more.

From the above-described viewpoints, as long as the shapes and the sizes of the first circumferential portion 1a, the second circumferential portion 1b, the third circumferential portion 3a, and the fourth circumferential portion 3b are the same in a portion of 60[%] or more of the entire length of these, it is possible to regard that the first circumferential portion 1a, the second circumferential portion 1b, the third circumferential portion 3a, and the fourth circumferential portion 3b are the same in shape and size. Note that in the above explanation, 60[%] is preferably 78[%], and more preferably 91[%] according to the minimum value βmin of the variable magnification β.

From the above, regarding the shapes and the sizes of the first circumferential portion 1a and the second circumferential portion 1b, the following can be said.

When the first coil 1 rotates by 180[°], a portion having a length of 60[%] or more of the entire length of the first circumferential portion 1a overlaps with a region where the second circumferential portion 1b existed before the aforementioned rotation. The entire length of the first circumferential portion 1a is a length from the first end if to the second end 1h of the first circumferential portion 1a.

In FIG. 3A, when it is set that the state illustrated by the solid line is brought into the state illustrated by the dotted line, the portion having a length of 60[%] or more of the entire length of the first circumferential portion 1a illustrated by a dotted line on the lower side overlaps with the second circumferential portion 1b illustrated by a solid line on the lower side in FIG. 3A.

Further, when the first coil 1 rotates by 180[°], a portion having a length of 60[%] or more of the entire length of the second circumferential portion 1b overlaps with a region where the first circumferential portion 1a existed before the aforementioned rotation. The entire length of the second circumferential portion 1b is a length from the first end 1g to the second end 1i of the second circumferential portion 1b.

In FIG. 3A, when it is set that the state illustrated by the solid line is brought into the state illustrated by the dotted line, the portion having a length of 60[%] or more of the entire length of the second circumferential portion 1b illustrated by a dotted line on the upper side overlaps with the first circumferential portion 1a illustrated by a solid line on the upper side in FIG. 3A.

Note that as described previously, in the above explanation, 60[%] is preferably 78[%], and more preferably 91[°] according to the minimum value βmin of the variable magnification β.

Next, the second coil 3 and the second supporting member 4 will be explained.

The second supporting member 4 is a member for supporting the second coil 3. The second coil 3 is fixed to the second supporting member 4. As illustrated in FIG. 2B, on the second supporting member 4, holes 4a to 4d intended for attaching the first supporting member 2 to the second supporting member 4 are formed. The holes 4a to 4d are holes for fixing the first supporting member 2 and the second supporting member 4 by using the supports 5a to 5d, the bolts 6a to 6d, and the nuts 7a to 7d. Diameters of the holes 4a to 4d are slightly larger than outside diameters of the bolts 6a to 6d. The holes 4e, 4f are holes through which the second coil 3 is led out to the outside. The first supporting member 2 and the second supporting member 4 cannot be moved in a state where the supports 5a, 5b, 5c, 5d and the bolts 6a, 6b, 6c, 6d are passed through the holes 4a, 4b, 4c, 4d, respectively, the positions of the supports 5a to 5d and the bolts 6a to 6d are fixed, and the nuts 7a to 7d are tightened. In the present embodiment, the supports 5a to 5d, the bolts 6a to 6d, and the nuts 7a to 7d function as a holding member. In the present embodiment, the holding member holds the first supporting member 2 to which the first coil 1 is fixed and the second supporting member 4 to which the second coil 3 is fixed so that the first coil 1 whose position was adjusted by the rotation is not moved, in a state where a set of the first circumferential portion 1a and the second circumferential portion 1b and a set of the third circumferential portion 3a and the fourth circumferential portion 3b become parallel with an interval provided therebetween.

As illustrated in FIG. 2B, the planar shape of the second supporting member 4 is square. However, the planar shape of the supporting member 2 of the second coil 4 is not limited to square. The planar shape of the supporting member 2 of the second coil 4 may be rectangle or circle, for example. The second supporting member 4 is formed of an insulating and non-magnetic material that has strength capable of supporting the second coil 3 so as to prevent the position of the second coil 3 in the Z-axis direction from changing. The second supporting member 4 is formed by using a glass laminated epoxy resin, a thermosetting resin, or the like, for example.

In FIG. 2B, the second coil 3 has the third circumferential portion 3a, the fourth circumferential portion 3b, a second connecting portion 3c, a third lead-out portion 3d, and a fourth lead-out portion 3e. The third circumferential portion 3a, the fourth circumferential portion 3b, the second connecting portion 3c, the third lead-out portion 3d, and the fourth lead-out portion 3e are integrated.

In the present embodiment, the number of turns of the second coil 3 is one [turn]. Further, in the present embodiment, a case where a figure of 8 in Arabic numerals is formed by the third circumferential portion 3a, the fourth circumferential portion 3b, and the second connecting portion 3c will be explained as an example. Note that in FIG. 3B, illustrations of the third lead-out portion 3d and the fourth lead-out portion 3e are omitted for convenience of illustration. Further, in FIG. 3B, the reference numerals and symbols are added to each of the two second coils 3 illustrated in an overlapping manner.

The third circumferential portion 3a is a portion circling so as to surround an inner region thereof. The fourth circumferential portion 3b is also a portion circling so as to surround an inner region thereof. The third circumferential portion 3a and the fourth circumferential portion 3b are arranged on the same horizontal plane (X-Y plane).

The second connecting portion 3c is a portion that connects a first end 3f of the third circumferential portion 3a and a first end 3g of the fourth circumferential portion 3b mutually, and is a non-circumferential portion.

The third lead-out portion 3d is connected to a second end 3h of the third circumferential portion 3a. The second end 3h of the third circumferential portion 3a is at a position of the hole 4e. The fourth lead-out portion 3e is connected to a second end 3i of the fourth circumferential portion 3b. The second end 3i of the fourth circumferential portion 3b is at a position of the hole 4f.

The third lead-out portion 3d and the fourth lead-out portion 3e become lead-out wires for connecting the second coil 3 to the outside. In FIG. 2B, each of the third lead-out portion 3d and the fourth lead-out portion 3e is illustrated by a dotted line, to thereby indicate that the third lead-out portion 3d and the fourth lead-out portion 3e exist on a surface opposite to the surface of the second supporting member 4 illustrated in FIG. 2B.

As described above, in the present embodiment, the second coil 3 does not rotate. However, in FIG. 3B, the second coil 3 is assumed to rotate. Accordingly, the second coil 3 is brought into a state illustrated by a dotted line from a state illustrated by a solid line when being rotated by 180 [°]. An axis (rotation axis) of the second coil 3 when the second coil 3 is assumed to rotate is an axis passing through a center 4g of the second supporting member 4 and in a direction perpendicular to a surface of the second supporting member 4 (in the Z-axis direction) (refer to FIG. 2B).

As illustrated in FIG. 2B, the center 4g of the second supporting member 4 (rotation axis) is arranged at a position including the middle position between a center 3j of the third circumferential portion 3a and a center 3k of the fourth circumferential portion 3b. The third circumferential portion 3a and the fourth circumferential portion 3b are positioned on the sides opposite to each other across the center 4g of the second supporting member 4 (the rotation axis of the second coil 3). Specifically, the third circumferential portion 3a and the fourth circumferential portion 3b are arranged so as to maintain a state where they are displaced by 180[°] in terms of angle in a direction in which the first coil 1 rotates. This angle is an angle formed by a virtual straight line mutually connecting the center 4g of the second supporting member 4 (rotation axis) and the center 3j of the third circumferential portion 3a at the shortest distance and a virtual straight line mutually connecting the center 4g of the second supporting member 4 (rotation axis) and the center 3k of the fourth circumferential portion 3b at the shortest distance. Note that in FIG. 2B, the center 4g of the second supporting member 4, the center 3j of the third circumferential portion 3a, and the center 3k of the fourth circumferential portion 3b are points illustrated virtually, and are not existent points.

Further, regarding the shapes and the sizes of the third circumferential portion 3a and the fourth circumferential portion 3b, the following can be said.

When it is assumed that the second coil 3 rotates by 180[°], a portion having a length of 60[%] or more of the entire length of the third circumferential portion 3a overlaps with a region where the fourth circumferential portion 3b existed before the aforementioned rotation. The entire length of the third circumferential portion 3a is a length from the first end 3f to the second end 3h of the third circumferential portion 3a.

In FIG. 3B, when it is assumed that the state illustrated by the solid line is brought into the state illustrated by the dotted line, the portion having a length of 60[%] or more of the entire length of the third circumferential portion 3a illustrated by a dotted line on the upper side overlaps with the fourth circumferential portion 3b illustrated by a solid line on the upper side in FIG. 3B.

Further, when it is assumed that the second coil 3 rotates by 180[°], a portion having a length of 60[%] or more of the entire length of the fourth circumferential portion 3b overlaps with a region where the third circumferential portion 3a existed before the aforementioned rotation. The entire length of the fourth circumferential portion 3b is a length from the first end 3g to the second end 3i of the fourth circumferential portion 3b.

In FIG. 3B, when it is set that the state illustrated by the solid line is brought into the state illustrated by the dotted line, the portion having a length of 60[%] or more of the entire length of the fourth circumferential portion 3b illustrated by a dotted line on the lower side overlaps with the third circumferential portion 3a illustrated by a solid line on the lower side in FIG. 3B.

Note that in the above explanation, 60[%] is preferably 78[%], and more preferably 91[%] according to the minimum value βmin of the variable magnification β.

Next, a method of arranging the first coil 1 and the second coil 3 will be explained.

As illustrated in FIG. 1, FIG. 2A, and FIG. 2B, the supports 5a to 5d are provided between the first supporting member 2 and the second supporting member 4 in order to prevent the positions in the Z-axis direction of the first coil 1 and the second coil 3 from changing. The supports 5a to 5d are the same in shape and size. In the present embodiment, the shape of each of the supports 5a to 5d is a hollow cylindrical shape. One end portions of the supports 5a, 5b, 5c, 5d are inserted in the moving holes 2a, 2b, 2c, 2d, the other end portions of the supports 5a, 5b, 5c, 5d are inserted in the holes 4a, 4b, 4c, 4d, and then the bolts 6a, 6b, 6c, 6d are passed through hollow portions of the supports 5a, 5b, 5c, 5d, respectively. At this time, the bolts 6a, 6b, 6c, 6d are inserted, from the upper side of FIG. 1, in the holes 4a, 4b, 4c, 4d, and the moving holes 2a, 2b, 2c, 2d. Further, the tips of the bolts 6a, 6b, 6c, 6d are made to project to below the second supporting member 4 (in the negative direction of Z-axis) in FIG. 1. The nuts 7a, 7b, 7c, 7d are attached to the projecting portions of the bolts 6a, 6b, 6c, 6d as described above, thereby fixing the first supporting member 2, the second supporting member 4, and the supports 5a, 5b, 5d, 5d with the use of the bolts 6a, 6h, 6c, 6d, and the nuts 7a, 7b, 7c, 7d. By designing as above, a relative positioning of the first supporting member 2 and the second supporting member 4 is realized, and a relative positional relationship of the two supporting members 2, 4 is fixed. Note that the supports 5a to 5d, the bolts 6a to 6d, and the nuts 7a to 7d are formed of an insulating and non-magnetic material that has strength capable of performing the relative positioning between the first supporting member 2 and the second supporting member 4.

In a manner as described above, the first coil 1 and the second coil 3 are arranged in a state of having a constant interval G therebetween so that coil surfaces thereof become parallel (refer to FIG. 1). The size of the interval G can be set to be larger than a value determined by an insulation distance between the first coil 1 and the second coil 3, and the like. Note that the term parallel does not necessarily indicate parallel in a strict manner, and it is possible to use the term parallel within a design tolerance range, for example. The same applies to the term “parallel” in the explanation below. Further, the coil surface of the first coil 1 is a horizontal plane (X-Y plane) in a region surrounded by the first circumferential portion 1a and the second circumferential portion 1b. The coil surface of the second coil 3 is a horizontal plane (X-Y plane) in a region surrounded by the third circumferential portion 3a and the fourth circumferential portion 3b.

Further, in the present embodiment, a position at which a projecting plane of the first coil 1 with respect to the second coil 3 and a projecting plane of the second coil 3 with respect to the first coil 1 are arranged to be mutually overlapped (a state illustrated in FIG. 2A and FIG. 2B) is set as an origin of design. In the present embodiment, the first coil 1 can rotate around this origin of design as a reference while maintaining a state where the coil surface thereof is parallel to the coil surface of the second coil 3.

In a state where the first coil 1 and the second coil 3 are not fixed by the bolts 6a to 6d and the nuts 7a to 7d via the supports 5a to 5d, at least the supports 5a to 5d and the bolts 6a to 6d are attached to the first supporting member 2 and the second supporting member 4. The moving hole 2a is coaxial with the rotation axis of the first coil 1, and has a size and a shape capable of making the supports 5a to 5d and the bolts 6a to 6d rotate. Therefore, in the state where the first coil 1 and the second coil 3 are not fixed by the bolts 6a to 6d and the nuts 7a to 7d via the supports 5a to 5d, at least the supports 5a to 5d and the bolts 6a to 6d are attached to the first supporting member 2 and the second supporting member 4, and in that state, the first supporting member 2 is rotated along the moving holes 2a to 2d, which makes it possible to adjust the position of the first supporting member 2. At the adjusted position, the first coil 1 and the second coil 3 are fixed by the bolts 6a to 6d and the nuts 7a to 7d via the supports 5a to 5d.

After that, the first coil 1 and the second coil 3 are connected to a not-illustrated alternating-current power supply circuit via the first lead-out portion 1d and the second lead-out portion 1e, and the third lead-out portion 3d and the fourth lead-out portion 3e, respectively, resulting in that they are configured as one reactor.

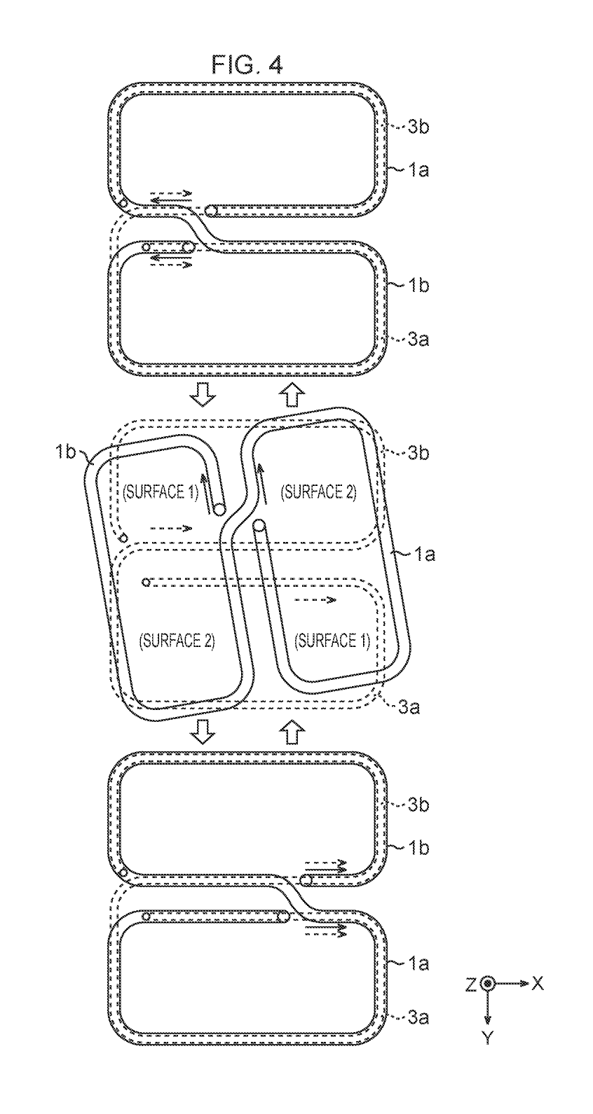

Note that in FIG. 2A and FIG. 2B, arrow lines illustrated in the first coil 1 and the second coil 3 are directions of alternating currents at the same time. The directions of the alternating currents flowing through the first coil 1 and the second coil 3 will be described later with reference to FIG. 4.

Next, the positional relationship between the first coil 1 and the second coil 3 will be explained.

FIG. 4 is a diagram illustrating one example of a positional relationship between the first coil 1 and the second coil 3. FIG. 4 is a diagram in which the first coil 1 and the second coil 3 are seen at the same time from a direction same as the direction in FIG. 2B. Specifically, FIG. 4 is a diagram in which the first coil 1 and the second coil 3 are seen through at the same time from a side opposite to a side of the attaching surface of the first coil 1, of the supporting member 2 of the first coil 1.

On the top of FIG. 4, an arrangement of the first coil 1 and the second coil 3 when the combined inductance GL becomes the minimum value is illustrated. On the bottom of FIG. 4, an arrangement of the first coil 1 and the second coil 3 when the combined inductance GL becomes the maximum value is illustrated. In the middle of FIG. 4, an arrangement of the first coil 1 and the second coil 3 when the combined inductance GL becomes an intermediate value (value greater than the minimum value and lower than the maximum value) is illustrated.

In FIG. 4, for convenience of illustration, the first coil 1 is illustrated by a solid line, and the second coil 3 is illustrated by a dotted line. Further, in FIG. 4, arrow lines indicated by a solid line and a dotted line indicate the directions of alternating currents flowing through the first coil 1 and the second coil 3 (when seen from the same direction at the same time), respectively.

The top and the middle of FIG. 4 illustrate the arrangements obtained when the first coil 1 rotates to move from the origin of design (the state illustrated on the bottom of FIG. 4).

The state illustrated on the bottom of FIG. 4 is set as a first state. Further, the state illustrated on the top of FIG. 4 is set as a second state.

As illustrated on the bottom of FIG. 4, the first state is a state where the first circumferential portion 1a of the first coil 1 and the third circumferential portion 3a of the second coil 3 are at positions facing each other, and the second circumferential portion 1b of the first coil 1 and the fourth circumferential portion 3b of the second coil 3 are at positions facing each other.

As illustrated on the top of FIG. 4, the second state is a state where the first circumferential portion 1a of the first coil 1 and the fourth circumferential portion 3b of the second coil 3 are at positions facing each other, and the second circumferential portion 1b of the first coil 1 and the third circumferential portion 3a of the second coil 3 are at positions facing each other.

Here, regarding the shapes and the sizes of the first circumferential portion 1a and the second circumferential portion 1b and the shapes and the sizes of the third circumferential portion 3a and the fourth circumferential portion 3b, the following can be said.

In the first state illustrated on the bottom of FIG. 4, when the first coil 1 and the second coil 3 are seen from the direction along the center axis (Z-axis direction), the portion having a length of 60[%] or more of the entire length of the first circumferential portion 1a and the portion having a length of 60[%] or more of the entire length of the third circumferential portion 3a overlap with each other. Further, in the first state, when the first coil 1 and the second coil 3 are seen from the direction along the center axis (Z-axis direction), the portion having a length of 60[°] or more of the entire length of the second circumferential portion 1b and the portion having a length of 60[%] or more of the entire length of the fourth circumferential portion 3b overlap with each other.

In the second state illustrated on the top of FIG. 4, when the first coil 1 and the second coil 3 are seen from the direction along the center axis (Z-axis direction), the portion having a length of 60[%] or more of the entire length of the first circumferential portion 1a and the portion having a length of 60[%] or more of the entire length of the fourth circumferential portion 3b overlap with each other. Further, in the second state, when the first coil 1 and the second coil 3 are seen from the direction along the center axis (Z-axis direction), the portion having a length of 60[%] or more of the entire length of the second circumferential portion 1b and the portion having a length of 60[%] or more of the entire length of the third circumferential portion 3a overlap with each other.

Note that in the above-described explanation, 60[%] is preferably 78[%], and more preferably 91[%] according to the minimum value βmin of the variable magnification β.

Here, a length of each of the first connecting portion 1c and the second connecting portion 3c is shorter than a length of each of the first circumferential portion 1a, the second circumferential portion 1b, the third circumferential portion 3a, and the fourth circumferential portion 3b. Therefore, there is no substantial difference even if the shapes and the sizes of the first coil 1 (the first circumferential portion 1a, the second circumferential portion 1b, and the first connecting portion 1c) and the second coil 3 (the third circumferential portion 3a, the fourth circumferential portion 3b, and the second connecting portion 3c) are the same in the portion of 60[%] or more (preferably 78[%] or more, and more preferably 91[%] or more) of the entire length of these.

Therefore, the aforementioned prescription made in the aforementioned explanation may be made with the shapes and the sizes of the first coil 1 (the first circumferential portion 1a, the second circumferential portion 1b, and the first connecting portion 1c) and the second coil 3 (the third circumferential portion 3a, the fourth circumferential portion 3b, and the second connecting portion 3c), in place of the shapes and the sizes of the first circumferential portion 1a, the second circumferential portion 1b, the third circumferential portion 3a, and the fourth circumferential portion 3b.

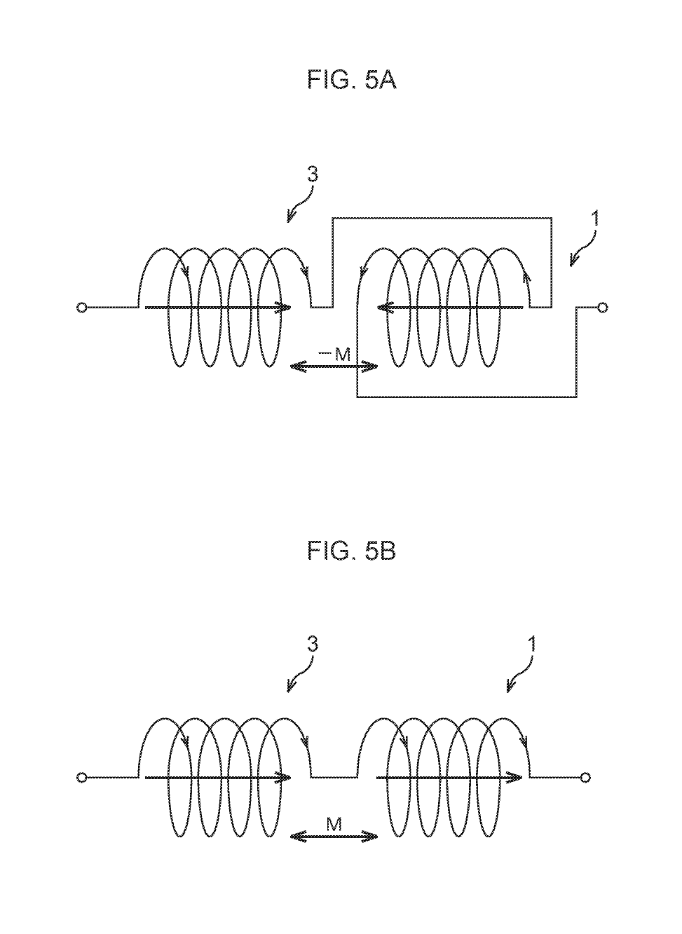

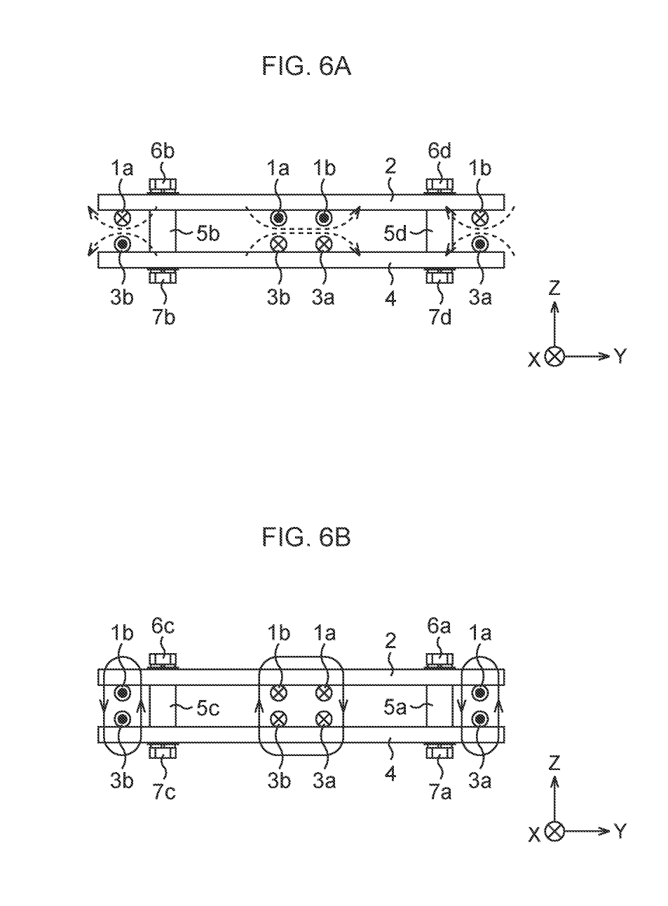

Next, one example of a method of adjusting the inductance in the reactor will be described while referring to FIG. 4, FIG. 5A, FIG. 5B, FIG. 6A, and FIG. 6B. The inductance in the reactor is the above-described combined inductance GL.

FIG. 5A, FIG. 5B, FIG. 6A, and FIG. 6B are diagrams each illustrating one example of directions of magnetic fluxes which are generated when the alternating current is applied to the first coil 1 and the second coil 3. In FIG. 5A and FIG. 5B, the directions of the magnetic fluxes are illustrated together with circuit symbols indicating the first coil 1 and the second coil 3. In FIG. 6A and FIG. 6B, the directions of the magnetic fluxes are illustrated together with the first coil 1 and the second coil 3 in a state of being configured and arranged as the reactor.

FIG. 5A and FIG. 6A are diagrams each illustrating the directions of the magnetic fluxes when the combined inductance GL becomes the minimum value. FIG. 5B and FIG. 6B are diagrams each illustrating the directions of the magnetic fluxes when the combined inductance GL becomes the maximum value. In FIG. 5A and FIG. 5B, arrows attached to the first coil 1 and the second coil 3 each indicate the direction of the alternating current, and arrow lines passing through the first coil 1 and the second coil 3 each indicate the direction of the magnetic flux. In FIG. 6A and FIG. 6B, the marks of ● and x each added inside ◯ indicate the direction of the alternating current. The mark of ● added inside ◯ indicates the direction from the far side of the sheet toward the near side, and the mark of x added inside ◯ indicates the direction from the near side of the sheet toward the far side. Further, arrow lines indicated by a dotted line in FIG. 6A and loops indicated by a solid line together with arrows in FIG. 6B indicate the directions of the magnetic fluxes.

In the second state illustrated on the top of FIG. 4, the first circumferential portion 1a of the first coil 1 and the fourth circumferential portion 3b of the second coil 3 are faced to each other, and the second circumferential portion 1b of the first coil 1 and the third circumferential portion 3a of the second coil 3 are faced to each other. Further, the direction of the alternating current flowing through the first circumferential portion 1a of the first coil 1 and the direction of the alternating current flowing through the second circumferential portion 3b of the second coil 3 (when seen from the same direction at the same time) are mutually opposite directions. Similarly, the direction of the alternating current flowing through the second circumferential portion 1b of the first coil 1 and the direction of the alternating current flowing through the third circumferential portion 3a of the second coil 3 (when seen from the same direction at the same time) are mutually opposite directions.

Therefore, as illustrated in FIG. 5A, the magnetic fluxes generated from the first coil 1 and the second coil 3 are mutually weakened. The combined inductance GL in this case is expressed by the following equation (3).

GL=L1+L2−2M (3)

The combined inductance GL expressed by the equation (3) becomes the minimum value of the combined inductance GL of the reactor.

At this time, the magnetic fluxes generated by applying the alternating current to the first coil 1 and the second coil 3 are as illustrated in FIG. 6A.

The first state illustrated on the bottom of FIG. 4 is a state where the first coil is rotated by 180[°] from the second state illustrated on the top of FIG. 4. In the first state, the first circumferential portion 1a of the first coil 1 and the third circumferential portion 3a of the second coil 3 are faced to each other, and the second circumferential portion 1b of the first coil 1 and the fourth circumferential portion 3b of the second coil 3 are faced to each other. Further, the direction of the alternating current flowing through the first circumferential portion 1a of the first coil 1 and the direction of the alternating current flowing through the third circumferential portion 3a of the second coil 3 (when seen from the same direction at the same time) are mutually the same direction. Similarly, the direction of the alternating current flowing through the second circumferential portion 1b of the first coil 1 and the direction of the alternating current flowing through the fourth circumferential portion 3b of the second coil 3 (when seen from the same direction at the same time) are mutually the same.

Therefore, as illustrated in FIG. 5B, the magnetic fluxes generated from the first coil 1 and the second coil 3 are mutually intensified. The combined inductance GL in this case is expressed by the following equation (4).

GL=L1+L2+2M (4)

The combined inductance expressed by the equation (4) becomes the maximum value of the combined inductance GL. At this time, the magnetic fluxes generated by applying the alternating current to the first coil 1 and the second coil 3 are as illustrated in FIG. 6B.

As described above, when the first coil 1 is rotated and moved by 180[°] from the second state illustrated on the top of FIG. 4, the first state illustrated on the bottom of FIG. 4 is made. By placing the first coil 1 at a position where the first coil 1 is rotated relative to the second coil 3, it is possible to make the directions of the alternating currents flowing through the first coil 1 and the second coil 3 (when seen from the same direction at the same time) to be mutually the same or opposite. Therefore, when the position of the first coil 1 in the first state illustrated on the bottom of FIG. 4 is set to 0[°], the rotation position of the first coil 1 is decided within a range of 0[°] to 180[°] and the first coil 1 is rotated to that position to be fixed, the combined inductance GL can be substantially accurately set and fixed to any value within a range from the minimum value to the maximum value thereof.

Concretely, when the first coil 1 is rotated to the middle of 0[°] and 180[°] and fixed as illustrated in the middle of FIG. 4, in portions indicated as (SURFACE 1) out of the coil surface of the first coil 1 and the coil surface of the second coil 3, the direction of the magnetic flux generated by the current flowing through the first coil 1 and the direction of the magnetic flux generated by the current flowing through the second coil 3 are mutually intensified. On the other hand, in portions indicated as (SURFACE 2), the direction of the magnetic flux generated by the current flowing through the first coil 1 and the direction of the magnetic flux generated by the current flowing through the second coil 3 are mutually weakened. Therefore, in the magnetic flux generated by the current flowing through the first coil 1 and the magnetic flux generated by the current flowing through the second coil 3, the mutually-intensified portions and the mutually-weakened portions are mixed. Therefore, the combined inductance GL becomes a numeric value between the minimum value and the maximum value thereof.

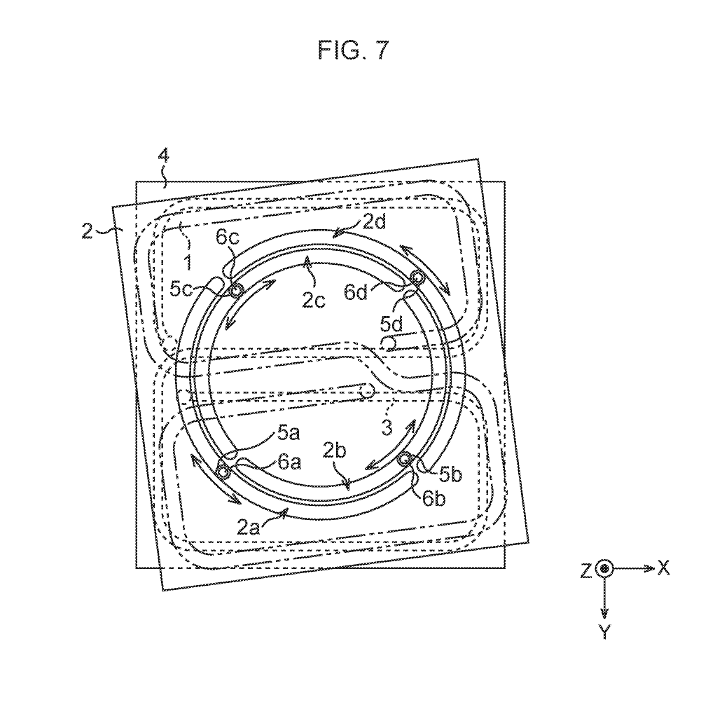

FIG. 7 is a diagram in which the first coil 1 and the first supporting member 2, and the second coil 3 and the second supporting member 4, are seen from the same direction. Concretely, FIG. 7 illustrates a diagram in which a surface of the supporting member 2, being the surface on a side opposite to the side of the attaching surface of the first coil 1, is seen through from above thereof (from a positive direction toward a negative direction of Z-axis).

In FIG. 7, it is designed such that in a state where the moving holes 2a, 2b, 2c, 2d formed on the supporting member 2, the supports 5a, 5b, 5c, 5d (positioned under the bolts 6a, 6b, 6c, 6d in FIG. 7) passing through the moving holes 2a, 2b, 2c, 2d, and the bolts 6a, 6b, 6c, 6d are fitted, respectively, the first coil 1 and the first supporting member 2 can be rotated in a stepless manner along the moving holes 2a, 2b, 2c, 2d.

In FIG. 7, in accordance with the rotation of the first coil 1 and the supporting member 2, the combined inductance GL becomes a value smaller than the maximum value. Therefore, it is possible to easily correct, through fine adjustment, a difference between an actual inductance value generated by an error in terms of production or the like and a design value of inductance. After the adjustment of inductance is terminated, in order to fix an inductance of the reactor by the adjusted inductance, the supports 5a to 5d, the bolts 6a to 6d, and the nuts 7a to 7d are used to fix a relative position between the first coil 1 and the first supporting member 2, and the second coil 3 and the second supporting member 4.

Next, members configuring the first coil 1 and the second coil 3 will be explained.

A conductor configuring the first coil 1 and the second coil 3 may employ any form. As the conductor configuring the first coil 1 and the second coil 3, for example, it is possible to use a water-cooled cable, an air-cooled cable, or a water-cooled copper pipe. Further, when a cable is used as the conductor configuring the first coil 1 and the second coil 3, it is possible to configure the cable with a single electric wire, or a plurality of electric wires (Litz wire, for example). According to the form of these electric wires, it is possible to make a large current (for example, a current of 100 [A] or more, preferably a current of 500 [A] or more) of high frequency (with several hundred [Hz] to several hundred [kHz]) flow through (the electric wires of) the first coil 1 and the second coil 3. By making the alternating current flow through the first coil 1, the first circumferential portion 1a and the second circumferential portion 1b create magnetic fields of mutually opposite directions. Similarly, by making the alternating current flow through the second coil 3, the third circumferential portion 3a and the fourth circumferential portion 3b create magnetic fields of mutually opposite directions.

After the first coil 1 is rotated and a predetermined inductance value is obtained as an inductance value of the reactor, the first coil 1 and the second coil 3 are fixed to the first supporting member 2 and the second supporting member 4, respectively, by using the bolts 6a to 6d and the nuts 7a to 7d. The first lead-out portion 1d, the second lead-out portion 1e, the third lead-out portion 3d, the fourth lead-out portion 3e, and fixed wires from the not-illustrated alternating-current power supply circuit are mutually connected. For example, one wire from the alternating-current power supply circuit is connected to the second lead-out portion 1e, the first lead-out portion 1d and the third lead-out portion 3d are mutually connected, and the fourth lead-out portion 3e is connected to the other wire from the alternating-current power supply. In this case, the first coil 1 and the second coil 3 are connected in series in an electrical manner. In a manner as above, the reactor is incorporated in the electric circuit. During a period in which the electric circuit having the reactor incorporated therein is operated (energized), the relative position between the first coil 1 and the first supporting member 2, and the second coil 3 and the second supporting member 4, is fixed and does not change.

As described above, in the present embodiment, the arc-shaped moving holes 2a, 2b, 2c, 2d are formed on the first supporting member 2, and the holes 4a to 4d are formed on the second supporting member 4. Further, in a state where the supports 5a, 5b, 5c, 5d, and the bolts 6a, 6b, 6c, 6d are inserted in the moving holes 2a, 2b, 2c, 2d, and the holes 4a, 4b, 4c, 4d, respectively, the first coil 1 attached to the first supporting member 2 is rotated along the moving holes 2a, 2b, 2c, 2d. Subsequently, by using the supports 5a to 5d, the bolts 6a to 6d, and the nuts 7a to 7d, the first supporting member 2 which supports the first coil 1 and the second supporting member 4 which supports the second coil 3 are fixed so that the coil surfaces of the first coil 1 and the second coil 3 become parallel.

Therefore, for example, by setting the design value of inductance to a value which is slightly smaller than the maximum value of the combined inductance GL, it is possible to reduce the difference between the actual inductance value generated by the error in terms of manufacture or the like and the design value of inductance by rotating the first coil 1. There is no need to change a shape, a size, and the number of turns of a coil, or change an interval (gap) between cores, as in the prior art. Therefore, it is possible to easily correct the inductance in quite a short period of time. This leads to a great reduction in cost. Therefore, it is possible to easily and accurately adjust an inductance value of a manufactured and assembled reactor to a target value. Besides, it is possible to apply reactors manufactured based on common design and manufacturing processes to a wide variety of products (for example, a power conversion circuit and a resonant circuit) in various products, for example. Therefore, it is possible to realize a reactor capable of easily changing an inductance in a wide range in accordance with a wide variety of specifications. Further, it is possible to make a high-frequency large current flow through the reactor. Note that a rotation amount of the first coil 1 from the origin of design when adjusting the inductance may be large or small.

### Modified Example 1

In the present embodiment, the explanation has been made by citing the case where, out of the first coil 1 and the second coil 3, the first coil 1 is rotated and the second coil 3 is fixed, as an example. However, it does not necessarily have to design as above as long as at least either the first coil 1 or the second coil 3 is designed to be rotated. For example, it is also possible that both of the first coil 1 and the second coil 3 are designed to be rotated. When it is designed as above, the second supporting member 4 of the second coil 3 is only required to be the same as the first supporting member 2 of the first coil 1, for example.

### Modified Example 2

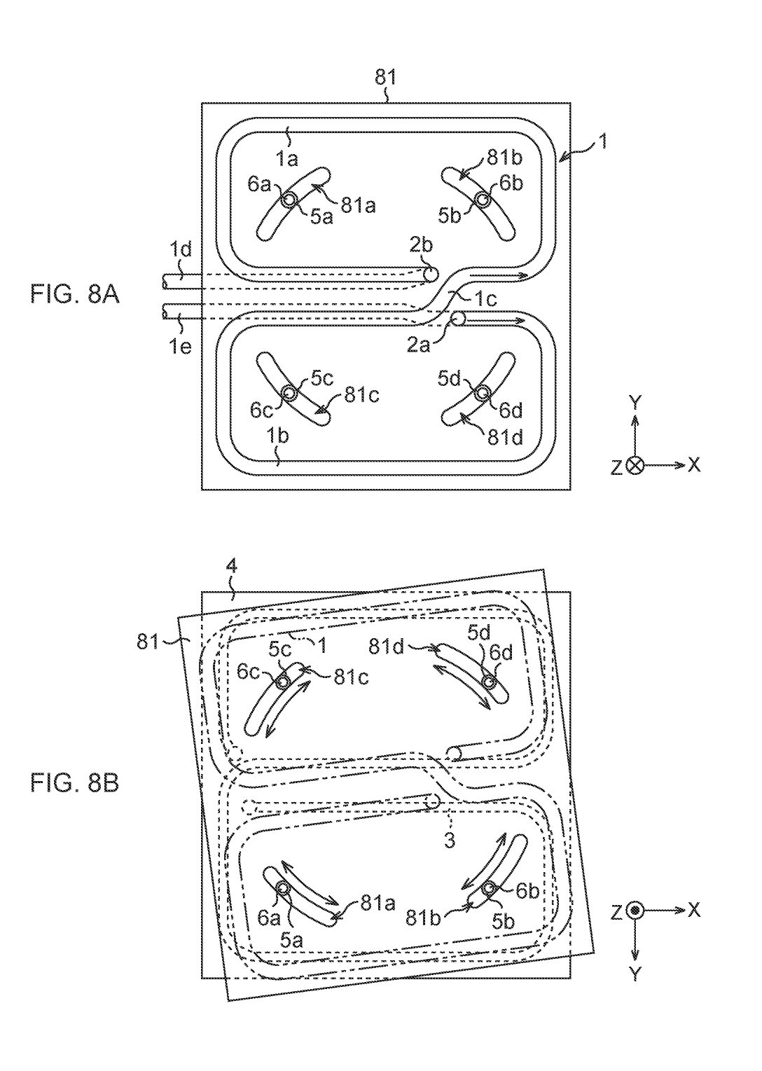

In the present embodiment, the explanation has been made by citing the case where the moving holes 2a, 2b, 2c, 2d are configured so that the first coil 1 rotates by 180[°] as an example. However, it does not necessarily have to design as above as long as the moving holes have a length capable of covering a range for correcting the difference between the actual inductance value generated by the error in terms of manufacture or the like and the design value of inductance. Each of FIG. 8A and FIG. 8B is a diagram illustrating a modified example of the moving holes. Concretely, FIG. 8A is a diagram corresponding to FIG. 2A, and is a diagram in which an attaching surface of the first coil 1 out of surfaces of a first supporting member 81 is seen along the Z-axis. Further, FIG. 8B is a diagram corresponding to FIG. 7, and is a diagram in which a surface on a side opposite to that of the attaching surface of the first coil 1 out of the surfaces of the first supporting member 81 is seen through from above thereof (diagram in which the surface is seen through from the positive direction toward the negative direction of Z-axis).

As illustrated in FIG. 8A and FIG. 8B, four independent moving holes 81a to 81d may be formed on the first supporting member 81. The moving holes 81a to 81d have arc shapes shorter than those of the moving holes 2a, 2b, 2c, 2d. When it is designed as above, the support 5a and the bolt 6a, the support 5b and the bolt 6b, the support 5c and the bolt 6c, and the support 5d and the bolt 6d, move in ranges where the moving holes 81a, 81b, 81c, 81d are formed, respectively. In this case, an angle at which the first coil 1 rotates is smaller than 180[°]. Note that also in the case of the present modified example, by making the second supporting member 4 to be the supporting member 81 illustrated in FIG. 8A and FIG. 8B, it is possible to employ a configuration of rotating the second coil 3, as in the modified example 1.

Here, a range of the total of an absolute value of the rotation angle of the first coil 1 in a first direction (for example, clockwise direction) and an absolute value of the rotation angle of the second coil 3 in a second direction (direction opposite to the first direction, for example, counterclockwise direction) can be set to 0° to 180° (namely, the maximum value of the total can be set to) 180°. When it is designed as above, by rotating both of the first coil 1 and the second coil 3, it is possible to continuously obtain the first state illustrated on the bottom of FIG. 4, the second state illustrated on the top of FIG. 4, and the state between these states.

### Modified Example 3

In the present embodiment, the explanation has been made by citing the case where the first coil 1 is rotated by forming the moving holes 2a, 2b, 2c, 2d on the first supporting member 2 as an example. However, it does not necessarily have to design as above as long as at least any one of the first coil 1 and the second coil 3 is rotated. For example, holes are formed at the positions of the centers 2g and 4g of the first supporting member 2 and the second supporting member 4, and a rotation shaft is inserted in the holes. At this time, it is designed such that the first supporting member 2 is coupled to the rotation shaft directly or via a member, and the second supporting member 4 is not coupled to the rotation shaft. Further, it is designed such that the rotation shaft can be fixed at a desired rotation angle. In a manner as above, only the first supporting member 2 out of the first supporting member 2 and the second supporting member 4 can be set to rotate to the desired rotation angle. After the first supporting member 2 is rotated to the desired rotation angle, the rotation shaft is fixed, to thereby prevent the first coil 3 from rotating. When it is designed as above, it is also possible to separately prepare the holding member which holds the first coil 1 and the second coil 3 so that a set of the first circumferential portion 1a and the second circumferential portion 1b and a set of the third circumferential portion 3a and the fourth circumferential portion 3b become parallel while having an interval therebetween, and the holding member which holds the first coil 1 and the second coil 3 so as to prevent the first coil 1 from rotating.

### Modified Example 4

In the present embodiment, the explanation has been made by citing the case where the first coil 1 and the second coil 3 are connected in series as an example. However, it is also possible that the first coil 1 and the second coil 3 are connected in parallel. Concretely, one wire from the alternating-current power supply circuit is connected to both of the first lead-out portion 1d and the third lead-out portion 3e, and the other wire from the alternating-current power supply circuit is connected to both of the second lead-out portion 1e and the fourth lead-out portion 3d.

When the first coil 1 and the second coil 3 are connected in parallel, the maximum value of the combined inductance GL is expressed by the following equation (5).

GL=(L1+M)×(L2+M)÷(L1+L2+2M) (5)

The combined inductance GL expressed by the equation (5) becomes the maximum value of the combined inductance GL at the time of parallel connection. Therefore, similarly to the case of serial connection, by setting the design value to be slightly smaller than the maximum value of the combined inductance GL, the combined inductance GL after the manufacture can be accurately adjusted and fixed in a short period of time.

### Modified Example 5

In the present embodiment, the explanation has been made by citing the case where the coil surfaces of the first coil 1 and the second coil 3 become parallel to each other in a state of having the constant interval G as an example. However, it does not necessarily have to design as above, and it is also possible to change the interval G by moving at least any one of the first coil 1 and the second coil 3 in the Z-axis direction. When the interval G is reduced, the mutual inductance M becomes a large value. On the other hand, when the interval G is increased, the mutual inductance M becomes a small value.

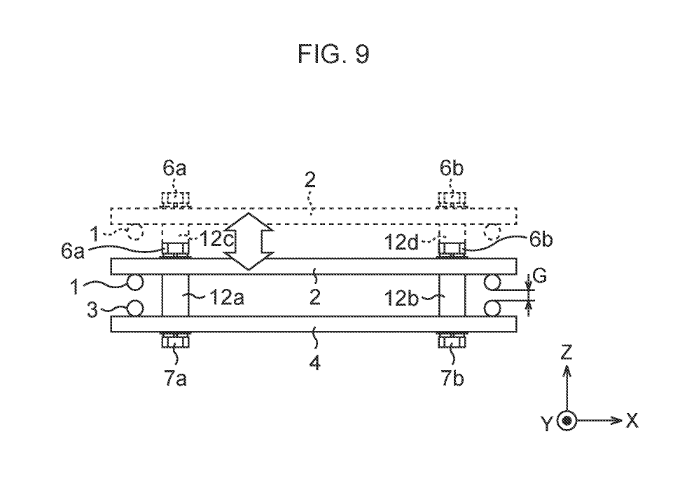

FIG. 9 is a diagram illustrating a configuration of a modified example of the reactor. FIG. 9 is a diagram corresponding to FIG. 1. Note that in FIG. 9, illustrations of the first lead-out portion 1d, the second lead-out portion 1e, the third lead-out portion 3d, and the fourth lead-out portion 3e are omitted for convenience of illustration. As illustrated in FIG. 9, for example, spacers 12a, 12b between the supporting member 2 of the first coil 1 and the supporting member 4 of the second coil 3 are changed to spacers 12c, 12d which are longer than the spacers 12a, 12b, to thereby increase the length between the supporting members 2 and 4. By designing as above, it is possible to change the interval G between the first coil 1 and the second coil 3.

### Modified Example 6

### Modified Example 6-1

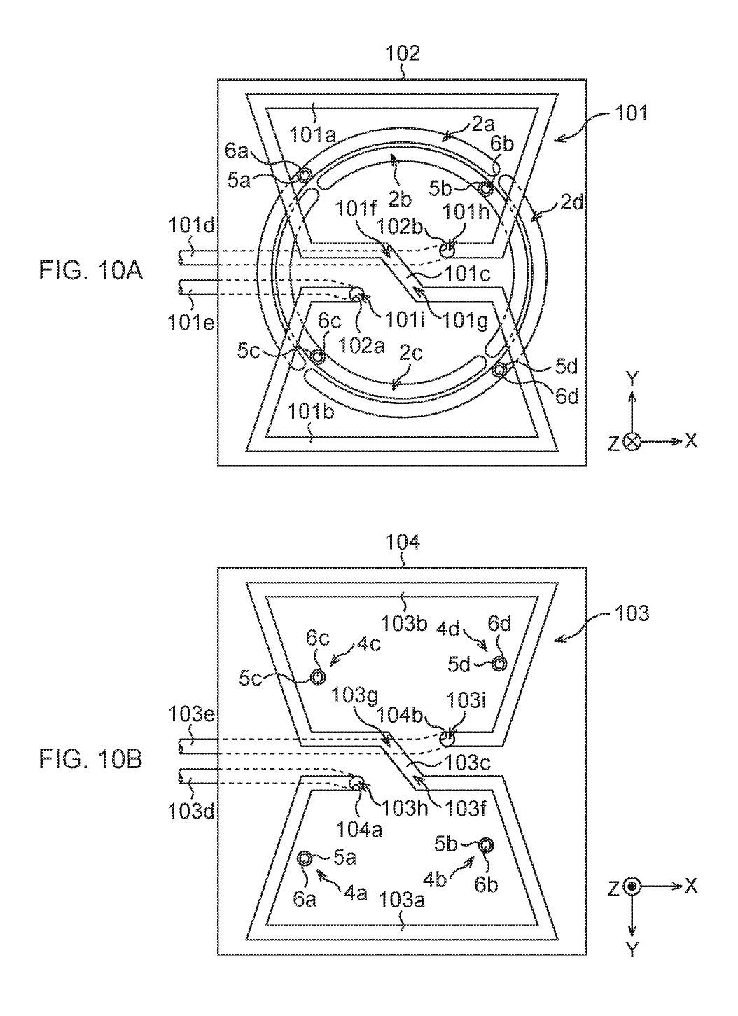

The shape formed by the first circumferential portion, the second circumferential portion, and the first connecting portion is not limited to the figure of 8 in Arabic numerals. Similarly, the shape formed by the third circumferential portion, the fourth circumferential portion, and the second connecting portion is also not limited to the figure of 8 in Arabic numerals. For example, such shapes as illustrated in FIG. 10A and FIG. 10B may be applied.

FIG. 10A is a diagram illustrating a first modified example of a first coil 101 and a first supporting member 102. FIG. 10B is a diagram illustrating a first modified example of a second coil 103 and a second supporting member 104. FIG. 10A is a diagram corresponding to FIG. 2A, and FIG. 10B is a diagram corresponding to FIG. 2B.

The first supporting member 102 is a member for supporting the first coil 101. The first coil 101 is fixed to the first supporting member 102. As illustrated in FIG. 10A, holes 102a, 102b are formed on the first supporting member 102. The holes 102a, 102b correspond to the holes 2e, 2f illustrated in FIG. 2A, and are holes through which the first coil 101 is led out to the outside. The first supporting member 102 is the same as the first supporting member 2 illustrated in FIG. 2A except that the holes 2e, 2f are changed to the holes 102a, 102b.

The first coil 101 has a first circumferential portion 101a, a second circumferential portion 101b, a first connecting portion 101c, a first lead-out portion 101d, and a second lead-out portion 101e. The first circumferential portion 101a, the second circumferential portion 101b, the first connecting portion 101c, the first lead-out portion 101d, and the second lead-out portion 101e are integrated.

The number of turns of the first coil 101 is one [turn]. The first circumferential portion 101a is a portion circling so as to surround an inner region thereof. The second circumferential portion 101b is also a portion circling so as to surround an inner region thereof. The first circumferential portion 101a and the second circumferential portion 101b are arranged on the same horizontal plane (X-Y plane).

The first connecting portion 101c is a portion that connects a first end 101f of the first circumferential portion 101a and a first end 101g of the second circumferential portion 101b mutually, and is a non-circumferential portion.

The first lead-out portion 101d is connected to a second end 101h of the first circumferential portion 101a. The second end 101h of the first circumferential portion 101a is at a position of the hole 102b. The second lead-out portion 101e is connected to a second end 101i of the second circumferential portion 101b. The second end 101i of the second circumferential portion 101b is at a position of the hole 102a.

The second supporting member 104 is a member for supporting the second coil 103. The second coil 103 is fixed to the second supporting member 104. As illustrated in FIG. 10B, holes 104a, 104b are formed on the second supporting member 104. The holes 104a, 104b correspond to the holes 4e, 4f, and are holes through which the second coil 103 is led out to the outside. The second supporting member 104 is the same as the second supporting member 2 illustrated in FIG. 2B except that the holes 4e, 4f are changed to the holes 104a, 104b.

The second coil 103 has a third circumferential portion 103a, a fourth circumferential portion 103b, a second connecting portion 103c, a third lead-out portion 103d, and a fourth lead-out portion 103e. The third circumferential portion 103a, the fourth circumferential portion 103b, the second connecting portion 103c, the third lead-out portion 103d, and the fourth lead-out portion 103e are integrated.

The number of turns of the second coil 103 is one [turn]. The third circumferential portion 103a is a portion circling so as to surround an inner region thereof. The fourth circumferential portion 103b is also a portion circling so as to surround an inner region thereof. The third circumferential portion 103a and the fourth circumferential portion 103b are arranged on the same horizontal plane (X-Y plane).

The second connecting portion 103c is a portion that connects a first end 103f of the third circumferential portion 103a and a first end 103g of the fourth circumferential portion 103b mutually, and is a non-circumferential portion.

The third lead-out portion 103d is connected to a second end 103h of the third circumferential portion 103a. The second end 103h of the third circumferential portion 103a is at a position of the hole 104a. The fourth lead-out portion 103e is connected to a second end 103i of the fourth circumferential portion 103b. The second end 103i of the fourth circumferential portion 103b is at a position of the hole 104b.

Note that the outermost peripheral contour shapes of the first circumferential portion, the second circumferential portion, the third circumferential portion, and the fourth circumferential portion may be another shape (for example, a perfect circle, an oval, or a rectangle).

### Modified Example 6-2

The connection between the first circumferential portion and the second circumferential portion, and the connection between the third circumferential portion and the fourth circumferential portion are not limited to the connections illustrated in FIG. 2A and FIG. 2B. Specifically, the directions of the alternating currents flowing through the first circumferential portion and the second circumferential portion, and the directions of the alternating currents flowing through the third circumferential portion and the fourth circumferential portion are not limited to the directions illustrated in FIG. 2A and FIG. 2B.

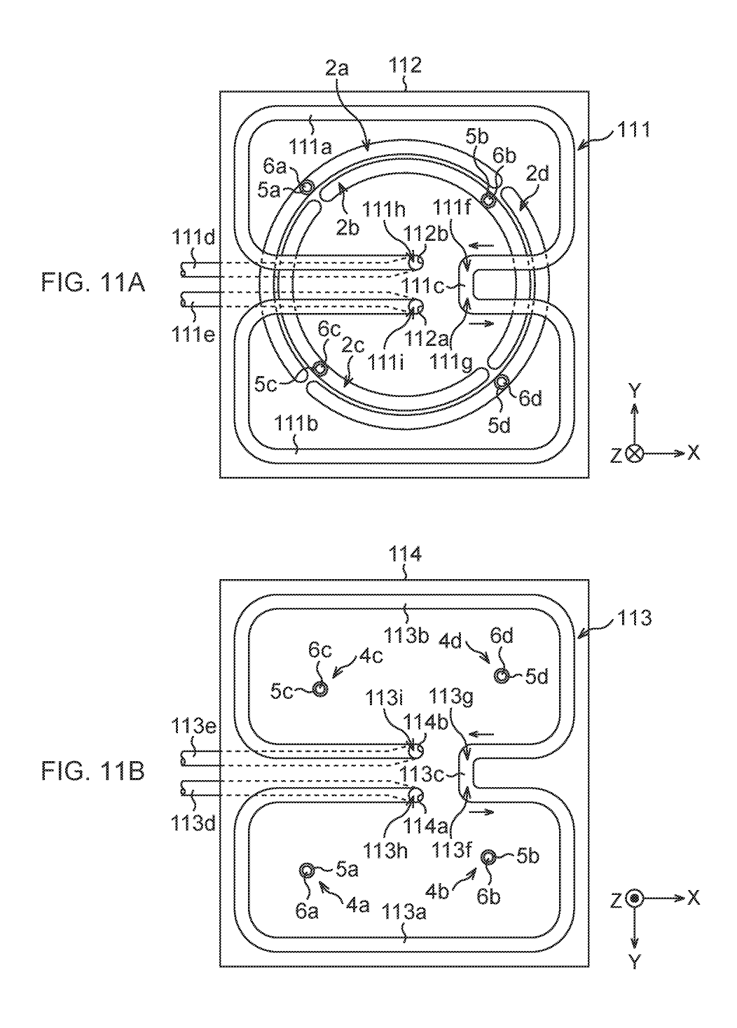

FIG. 11A is a diagram illustrating a second modified example of a first coil 111 and a first supporting member 112. FIG. 11B is a diagram illustrating a second modified example of a second coil 113 and a second supporting member 114. FIG. 11A is a diagram corresponding to FIG. 2A, and FIG. 11B is a diagram corresponding to FIG. 2B.

The first supporting member 112 is a member for supporting the first coil 111. The first coil 111 is fixed to the first supporting member 112. As illustrated in FIG. 11A, holes 112a, 112b are formed on the first supporting member 112. The holes 112a, 112b correspond to the holes 2e, 2f illustrated in FIG. 2A, and are holes through which the first coil 111 is led out to the outside. The first supporting member 112 is the same as the first supporting member 2 illustrated in FIG. 2A except that the holes 2e, 2f are changed to the holes 112a, 112b.

The first coil 111 has a first circumferential portion 111a, a second circumferential portion 111b, a first connecting portion 111c, a first lead-out portion 111d, and a second lead-out portion 111e. The first circumferential portion 111a, the second circumferential portion 111b, the first connecting portion 111c, the first lead-out portion 111d, and the second lead-out portion 111e are integrated.

The number of turns of the first coil 111 is one [turn]. The first circumferential portion 111a is a portion circling so as to surround an inner region thereof. The second circumferential portion 111b is also a portion circling so as to surround an inner region thereof. The first circumferential portion 111a and the second circumferential portion 111b are arranged on the same horizontal plane (X-Y plane).

The first connecting portion 111c is a portion that connects a first end 111f of the first circumferential portion 111a and a first end 111g of the second circumferential portion 111b mutually, and is a non-circumferential portion.

The first lead-out portion 111d is connected to a second end 111h of the first circumferential portion 111a. The second end 111h of the first circumferential portion 111a is at a position of the hole 112b. The second lead-out portion 111e is connected to a second end 111i of the second circumferential portion 111b. The second end 111i of the second circumferential portion 111b is at a position of the hole 112a.

The second supporting member 114 is a member for supporting the second coil 113. The second coil 113 is fixed to the second supporting member 114. As illustrated in FIG. 11B, holes 114a, 114b are formed on the second supporting member 114. The holes 114a, 114b correspond to the holes 4e, 4f, and are holes through which the second coil 113 is led out to the outside. The second supporting member 114 is the same as the second supporting member 2 illustrated in FIG. 2B except that the holes 4e, 4f are changed to the holes 114a, 114b.

The second coil 113 has a third circumferential portion 113a, a fourth circumferential portion 113b, a second connecting portion 113c, a third lead-out portion 113d, and a fourth lead-out portion 113e. The third circumferential portion 113a, the fourth circumferential portion 113b, the second connecting portion 113c, the third lead-out portion 113d, and the fourth lead-out portion 113e are integrated.

The third circumferential portion 113a is a portion circling so as to surround an inner region thereof. The fourth circumferential portion 113b is also a portion circling so as to surround an inner region thereof. The third circumferential portion 113a and the fourth circumferential portion 113b are arranged on the same horizontal plane (X-Y plane).

The second connecting portion 113c is a portion that connects a first end 113f of the third circumferential portion 113a and a first end 113g of the fourth circumferential portion 113b mutually, and is a non-circumferential portion.

The third lead-out portion 113d is connected to a second end 113h of the third circumferential portion 113a. The second end 113h of the third circumferential portion 113a is at a position of the hole 114a. The fourth lead-out portion 113e is connected to a second end 113i of the fourth circumferential portion 113b. The second end 113i of the fourth circumferential portion 113b is at a position of the hole 114b.

In the configuration illustrated in FIG. 2A and FIG. 2B, at the same time, the current flows counterclockwise in the first circumferential portion 1a, the current flows clockwise in the second circumferential portion 1b, the current flows clockwise in the third circumferential portion 3a, and the current flows counterclockwise in the fourth circumferential portion 3b with respect to the sheets of FIG. 2A and FIG. 2B. Therefore, the directions of the currents flowing through the two circumferential portions (the first circumferential portion 1a and the second circumferential portion 1b, the third circumferential portion 3a and the fourth circumferential portion 3b) are opposite directions.

In contrast to this, in the configuration illustrated in FIG. 11A and FIG. 11B, at the same time, the current flows clockwise in the first circumferential portion 111a and the second circumferential portion 111b, and the current flows clockwise in the third circumferential portion 113a and the fourth circumferential portion 113b with respect to the sheets of FIG. 11A and FIG. 11B. Therefore, the directions of the currents flowing through the two circumferential portions (the first circumferential portion 111a and the second circumferential portion 111b, the third circumferential portion 113a and the fourth circumferential portion 113b) are the same direction (refer to the arrow lines illustrated beside the first coil 111 and the second coil 113 in FIG. 11A and FIG. 11B). The variable magnification β of the combined inductance GL when seen from the alternating-current power supply circuit in the case illustrated in FIG. 11A and FIG. 11B differs from that in the case of the configuration illustrated in FIG. 2A and FIG. 2B, but, the principle that changes the combined inductance GL is the same in all of the configurations illustrated in FIG. 2A, FIG. 2B, and FIG. 11A, FIG. 11B.

### Second Embodiment

Next, a second embodiment will be explained. In the first embodiment, the case where the first coil 1 is rotated has been explained as an example. On the contrary, in the present embodiment, a case where the first coil 1 is moved in parallel in a direction perpendicular to the Z-axis (a direction along the coil surface of the first coil 1) will be explained as an example. Note that the term perpendicular does not necessarily indicate perpendicular in a strict manner, and it is possible to use the term perpendicular within a design tolerance range, for example. The same applies to the term “perpendicular” in the explanation below. As described above, the present embodiment and the first embodiment mainly differ in a part of the configuration for moving the first coil 1. Therefore, in the explanation of the present embodiment, the same reference numerals and symbols as those added to FIG. 1 to FIG. 11B are added to the same parts as those in the first embodiment, or the like, and detailed explanation will be omitted.

The difference between the present embodiment and the first embodiment lies in the moving holes formed on the first supporting member 2.

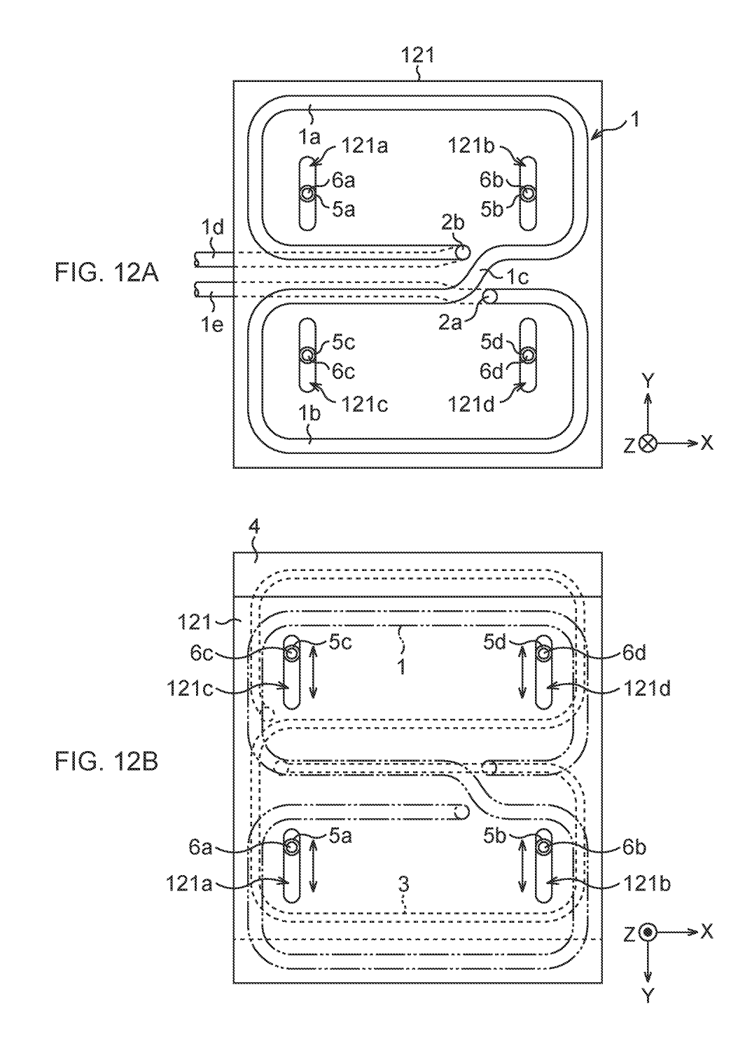

FIG. 12A is a diagram illustrating one example a configuration of a first supporting member 121 of the present embodiment. FIG. 12A is a diagram corresponding to FIG. 2A. FIG. 12A is a diagram in which an attaching surface of the first coil 1 out of surfaces of the first supporting member 121 is seen along the Z-axis. FIG. 12B is a diagram in which the first coil 1 and the first supporting member 121, and the second coil 3 and the second supporting member 4, are seen from the same direction. FIG. 12B is a diagram corresponding to FIG. 7. FIG. 12B is a diagram in which a surface on a side opposite to that of the attaching surface of the first coil 1 out of the surfaces of the first supporting member 121 is seen through from above thereof (diagram in which the surface is seen through from the positive direction toward the negative direction of Z-axis).

As illustrated in FIG. 12A, moving holes 121a to 121d in the longitudinal direction (in the Y-axis direction in FIG. 12) have track shapes (shapes in each of which short sides of a rectangle are projected to the outside to form semi-arc shapes) which are parallel to one another. The moving holes 121a to 121d are the same in shape and size. The positions in the Y-axis direction and the positions in the Z-axis direction of the moving holes 121a, 121b are the same, and the positions in the X-axis direction of the moving holes 121a, 121b are different. The positions in the Y-axis direction and the positions in the Z-axis direction of the moving holes 121c, 121d are the same, and the positions in the X-axis direction of the moving holes 121c, 121d are different. Further, the positions in the X-axis direction and the positions in the Z-axis direction of the moving holes 121a, 121c are the same, and the positions in the Y-axis direction of the moving holes 121a, 121c are different. The positions in the X-axis direction and the positions in the Z-axis direction of the moving holes 121b, 121d are the same, and the positions in the Y-axis direction of the moving holes 121b, 121d are different. The moving holes 121a to 121d have sizes and shapes capable of making the supports 5a, 5b, 5c, 5d and the bolts 6a, 6b, 6c, 6d inserted in the moving holes 121a, 121b, 121c, 121d move in parallel in the Y-axis direction. Note that the shapes, the sizes, and the positions do not necessarily have to be the same in a strict manner, and it can be said that they are the same within a design tolerance range, for example.

As illustrated in FIG. 12B, it is designed such that in a state where the moving holes 121a, 121b, 121c, 121d formed on the first supporting member 121 to which the first coil 1 is attached, the supports 5a, 5b, 5c, 5d passing through the moving holes 121a, 121b, 121c, 121d, and the bolts 6a, 6b, 6c, 6d are fitted, respectively, the first coil 1 and the first supporting member 121 can be moved in parallel in a stepless manner along the moving holes 121a, 121b, 121c, 121d. In FIG. 12B, the supports 5a, 5b, 5c, 5d are positioned under the bolts 6a, 6b, 6c, 6d (on the negative direction side of the Z-axis). In a manner as above, the support 5a and the bolt 6a, the support 5b and the bolt 6b, the support 5c and the bolt 6c, and the support 5d and the bolt 6d, move in ranges where the moving holes 121a, 121b, 121c, 121d are formed, respectively. For this reason, the first supporting member 121 to which the first coil 1 is attached moves in parallel in the Y-axis direction, as illustrated in FIG. 12B.

In FIG. 12B, in accordance with the parallel movement of the first coil 1 and the first supporting member 121, the combined inductance GL becomes a value smaller than the maximum value. Therefore, it is possible to easily correct, through fine adjustment, a difference between an actual inductance value generated by an error in terms of production or the like and a design value of inductance. After the adjustment of inductance is terminated, in order to fix an inductance of the reactor by the adjusted inductance, the supports 5a to 5d, the bolts 6a to 6d, and the nuts 7a to 7d are used to fix a relative position of the first supporting member 121 and the second supporting member 4. In the present embodiment, the supports 5a to 5d, 12a, 12b, the bolts 6a to 6d, and the nuts 7a to 7d function as a holding member. In the present embodiment, the holding member holds the first coil 1 and the second coil 3 so as to prevent the first coil 1 whose position was adjusted by the parallel movement from moving, in a state where a set of the first circumferential portion 1a and the second circumferential portion 1b and a set of the third circumferential portion 3a and the fourth circumferential portion 3b become parallel with an interval provided therebetween.

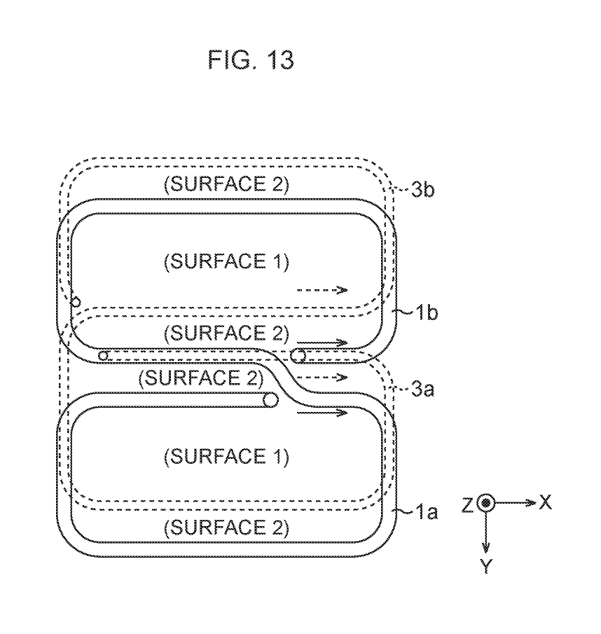

FIG. 13 is a diagram illustrating one example of a positional relationship between the first coil 1 and the second coil 3. FIG. 13 is a diagram corresponding to the bottom diagram of FIG. 4. Note that examples of the arrangement of the first coil 1 and the second coil 3 when the combined inductance GL becomes the minimum value and when the combined inductance GL becomes the maximum value are the same as the top diagram of FIG. 4 and the middle diagram of FIG. 4, respectively.

As illustrated in FIG. 13, when the first coil 1 is moved in parallel in the Y-axis direction to be fixed, in portions indicated as (SURFACE 1) in the coil surface of the first coil 1 and the coil surface of the second coil 3, the direction of the magnetic flux generated by the current flowing through the first coil 1 and the direction of the magnetic flux generated by the current flowing through the second coil 3 are mutually intensified. On the other hand, in portions indicated as (SURFACE 2), the direction of the magnetic flux generated by the current flowing through the first coil 1 and the direction of the magnetic flux generated by the current flowing through the second coil 3 are mutually weakened. Therefore, in the magnetic flux generated by the current flowing through the first coil 1 and the magnetic flux generated by the current flowing through the second coil 3, the mutually-intensified portions and the mutually-weakened portions are mixed. Therefore, the combined inductance GL becomes a numeric value between the minimum value and the maximum value thereof.

As described above, an effect similar to that of the first embodiment can be achieved even when the first coil 1 is moved in parallel with respect to the second coil 3.

Also in the present embodiment, it is possible to adopt modified examples of the modified examples 1, 3 to 6 explained in the first embodiment. Further, it does not necessarily have to configure the moving holes 121a to 121d as illustrated in FIG. 12A and FIG. 12B as long as the moving holes have a length capable of covering a range for correcting the difference between the actual inductance value generated by the error in terms of manufacture or the like and the design value of inductance. For example, two moving holes being a moving hole as a result of connecting the moving holes 121a and 121c, and a moving hole as a result of connecting the moving holes 121b and 121d, may be formed on the first supporting member. Further, it is also possible to design such that the second supporting member 4 is changed to the first supporting member 2 explained in the first embodiment so that the first coil 1 is moved in parallel and the second coil 3 is rotated.

Note that in the present embodiment, the first coil 1 and the second coil 3 do not rotate. Therefore, in the present embodiment, the prescription described in the first embodiment is applied regarding the shapes and the sizes of the first circumferential portion 1a, the second circumferential portion 1b, the third circumferential portion 3a, and the fourth circumferential portion 3b by assuming that the first coil 1 and the second coil 3 rotate similarly to the first embodiment.

### Third Embodiment

Next, a third embodiment will be explained. In the first embodiment, the explanation has been made by citing the case where the first coil 1 is rotated as an example, and in the second embodiment, the explanation has been made by citing the case where the first coil 1 is moved in parallel as an example. On the contrary, in the present embodiment, explanation will be made by citing a case where both of the rotation and the parallel movement of the first coil 1 are realized as an example. As described above, the present embodiment and the first and second embodiments mainly differ in a part of the configuration for moving the first coil 1. Therefore, in the explanation of the present embodiment, the same reference numerals and symbols as those added to FIG. 1 to FIG. 13 are added to the same parts as those in the first and second embodiments, or the like, and detailed explanation will be omitted.

The difference between the present embodiment and the first and second embodiments lies in the moving holes formed on the first supporting member 2.

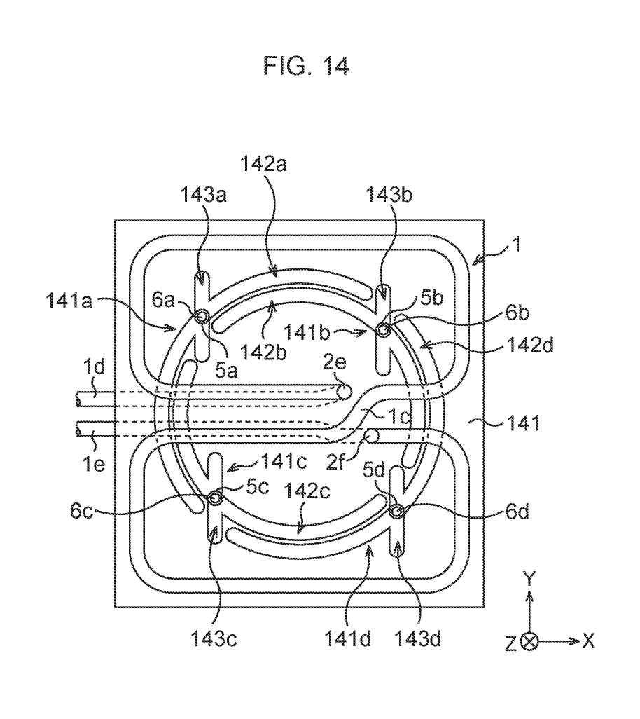

FIG. 14 is a diagram illustrating one example a configuration of the first coil 1 and a first supporting member 141 of the present embodiment. FIG. 14 is a diagram corresponding to FIG. 2A, and is a diagram in which an attaching surface of the first coil 1 out of surfaces of the first supporting member 141 is seen along the Z-axis.

As illustrated in FIG. 14, moving holes 141a, 141b, 141c, 141d respectively have arc-shaped regions 142a, 142b, 142c, 142d, and projecting regions 143a, 143b, 143c, 143d. The moving holes 141a, 141b, 141c, 141d are obtained by combining the moving holes 2a, 2b, 2c, 2d explained in the first embodiment and the moving holes 121a, 121b, 121c, 121d explained in the second embodiment, respectively. However, portions overlapped with the moving holes 121a, 121b, 121c, 121d are removed from the regions of the moving holes 2a, 2b, 2c, 2d.

It is designed such that in a state where the moving holes 141a, 141b, 141c, 141d formed on the first supporting member 141 to which the first coil 1 is attached, the supports 5a, 5b, 5c, 5d passing through the moving holes 141a, 141b, 141c, 141d, and the bolts 6a, 6b, 6c, 6d are fitted, respectively, the first coil 1 and the first supporting member 141 can rotate along the arc-shaped regions 142a, 142b, 142c, 142d of the moving holes 141a, 141b, 141c, 141d.

Further, it is designed such that in a state where the supports 5a, 5b, 5c, 5d and the bolts 6a, 6b, 6c, 6d are positioned at the projecting regions 143a, 143b, 143c, 143d, respectively, the first supporting member 141 is moved along the projecting regions 143a, 143b, 143c, 143d, which enables to make the first coil 1 and the first supporting member 141 move in parallel. In the present embodiment, the supports 5a to 5d, 12a, 12b, the bolts 6a to 6d, and the nuts 7a to 7d function as a holding member. In the present embodiment, the holding member holds the first coil 1 and the second coil 3 so as to prevent the first coil 1 whose position was adjusted by both or either of the rotation and the parallel movement from moving, in a state where a set of the first circumferential portion 1a and the second circumferential portion 1b and a set of the third circumferential portion 3a and the fourth circumferential portion 3b become parallel with an interval provided therebetween.

As described above, an effect similar to that of the first and second embodiments can be achieved even when the first coil 1 is rotated and moved in parallel with respect to the second coil 3. Besides, by designing as above, it is possible to further widen the adjustment range of the inductance value of the reactor. Further, also in the present embodiment, it is possible to adopt the various modified examples explained in the first and second embodiments.

### Fourth Embodiment

Next, a fourth embodiment will be explained. In the first to third embodiments, the case where the number of turns of each of the first coil 1 and the second coil 3 is one [turn] has been explained as an example. On the contrary, in the present embodiment, a case where the number of turns of each of a first coil and a second coil is plural turns will be explained. The present embodiment as above and the first to third embodiments mainly differ in the number of turns of the first coil and the second coil. Therefore, in the explanation of the present embodiment, the same reference numerals and symbols as those added to FIG. 1 to FIG. 14 are added to the same parts as those in the first embodiment, or the like, and detailed explanation will be omitted.

### First Example

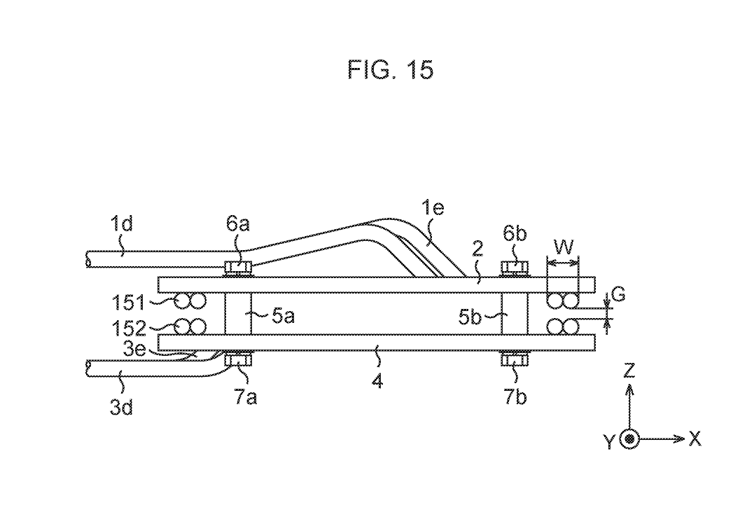

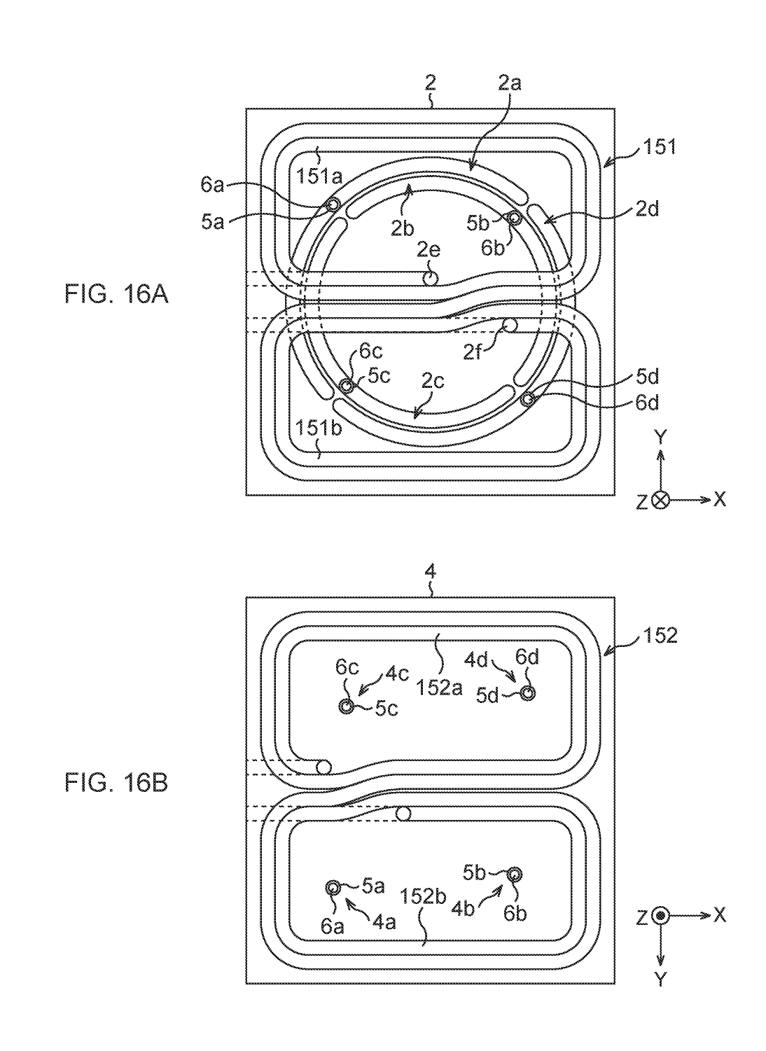

FIG. 15 is a diagram illustrating a first example of a configuration of a reactor of the present embodiment. FIG. 15 is a diagram corresponding to FIG. 1. FIG. 16A is a diagram illustrating one example of a configuration of a first coil 151 and the first supporting member 2. FIG. 16B is a diagram illustrating one example of a configuration of a second coil 152 and the second supporting member 4. FIG. 16A and FIG. 16B are diagrams corresponding to FIG. 2A and FIG. 2B, respectively.

In the present example, as illustrated in FIG. 15, FIG. 16A, and FIG. 16B, the number of turns of each of the first coil 151 and the second coil 152 is set to two turns, and thus the same number of turns is set. Further, as illustrated in FIG. 15, FIG. 16A, and FIG. 16B, the shape of each of the first coil 151 and the second coil 152 is set to a flat spiral shape. Here, the flat spiral means that a coil is wound around plural times in a direction parallel to the coil surface as illustrated in FIG. 15, FIG. 16A, and FIG. 16B.

If the first coil 151 and the second coil 152 are each formed in a flat spiral shape as described above, it is possible to widen a coil width W illustrated in FIG. 15 when the first coil 151 and the second coil 152 are arranged so as to make their coil surfaces to be parallel to each other with the intervals G provided therebetween. The coil width W means the length in a direction parallel to the coil surface (in the X-axis direction in FIG. 15) of a group of conductors adjacent to each other when forming the coil. As long as the intervals G are the same, as the coil width W is wider, magnetic fluxes do not easily pass through between the intervals G and magnetic reluctance becomes larger. Therefore, the mutual inductance M between the first coil 151 and the second coil 152 becomes large. Also in the present embodiment, it is possible to reduce the difference between the actual inductance value generated by the error in terms of manufacture or the like and the design value of inductance by rotating the first coil 151, with the use of a method similar to that explained in the first embodiment.

As described above, an effect similar to that of the first embodiment can be achieved even when the shape of each of the first coil 151 and the second coil 152 is set to a flat spiral shape and the number of turns of each of the first coil 151 and the second coil 152 is set to plural turns.

### Second Example

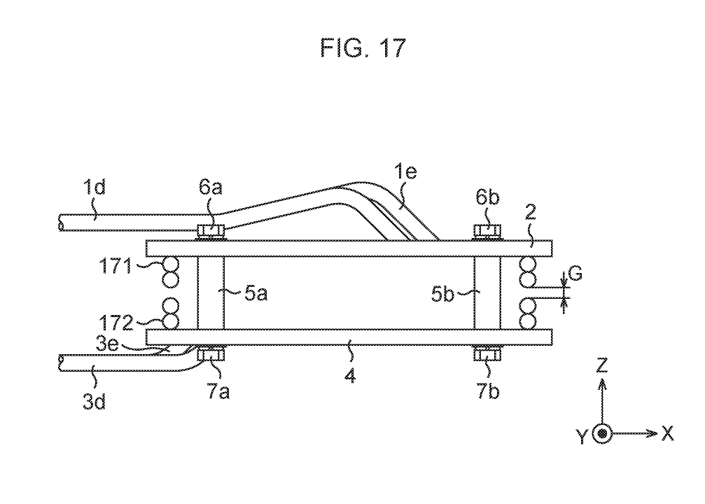

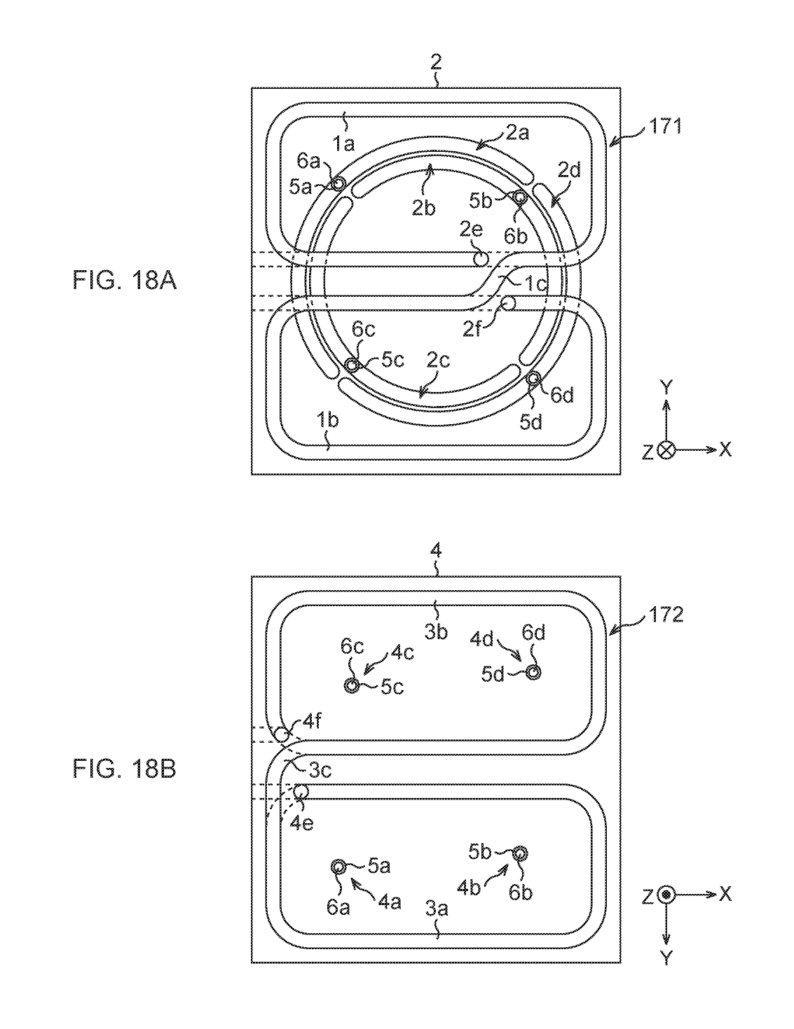

FIG. 17 is a diagram illustrating a second example of a configuration of a reactor of the present embodiment. FIG. 17 is a diagram corresponding to FIG. 1. FIG. 18A is a diagram illustrating one example of a configuration of a first coil 171 and the first supporting member 2. FIG. 18B is a diagram illustrating one example of a configuration of a second coil 172 and the second supporting member 4. FIG. 18A and FIG. 18B are diagrams corresponding to FIG. 2A and FIG. 2B, respectively.

In the present example, as illustrated in FIG. 17, FIG. 18A, and FIG. 18B, the number of turns of each of the first coil 171 and the second coil 172 is set to two turns, and thus the same number of turns is set. Further, as illustrated in FIG. 17, FIG. 18A, and FIG. 18B, the shape of each of the first coil 171 and the second coil 172 is set to a longitudinally wound shape. Here, the longitudinally winding means that a coil is wound around plural times in a direction perpendicular to the coil surface (in the Z-axis direction in FIG. 17) as illustrated in FIG. 17, FIG. 18A, and FIG. 18B.

In the case of the longitudinally wound shape as above, the coil width W is the same as that in the case where the number of turns is one turn.

When the same number of turns is set, the mutual inductance M between the two coils becomes small in the longitudinally wound shape, when compared to the flat spiral shape. However, the method of adjusting the inductance as the reactor does not differ between the flat spiral shape and the longitudinally wound shape.

As described above, an effect similar to that of the first embodiment can be achieved even when the shape of each of the first coil 171 and the second coil 172 is set to a longitudinally wound shape and the number of turns of each of the first coil 171 and the second coil 172 is set to plural turns.

### Modified Example

In the present embodiment, the case where the number of turns is two turns has been explained as an example. However, the number of turns is not limited to two turns, and may be three turns or more. The number of turns only needs to be determined according to the size of the reactor, the magnitude of the combined inductance GL, the cost of the reactor, and the like. Further, in the present embodiment, the case where the number of turns of the first coil 151 and the number of turns of the second coil 152 arc the same and the number of turns of the first coil 171 and the number of turns of the second coil 172 are the same has been explained as an example. However, they may be different in the number of turns of these.

Further, in the present embodiment, the case where the first coils 151, 171, and the second coils 152, 172 are applied to the first supporting member 2 explained in the first embodiment has been explained as an example. However, for example, it is also possible to apply the first coils 151, 171, and the second coils 152, 172 to the first supporting member 81, 121, or 141 explained in the modified example 2 of the first embodiment, the second embodiment, or the third embodiment. Further, it is also possible to apply the method of the present embodiment to the first coils 101, 111 and the second coils 103, 113 explained in the modified example 6 of the first embodiment.

Further, also in the present embodiment, the various modified examples explained in the first to third embodiments can be employed.

### Fifth Embodiment

Next, a fifth embodiment will be explained. In the first to fourth embodiments, the explanation has been made by citing the case where the two supporting members each having one coil attached thereto (the first supporting member 2 and the second supporting member 4, for example) are arranged in parallel so that the distance between the coils becomes the interval G, as an example. On the contrary, in the present embodiment, explanation will be made by citing a case where there are plural coils to be attached to one supporting member (each of the first supporting member 2 and the second supporting member 4, for example) as an example. As described above, the present embodiment and the first to fourth embodiments mainly differ in the configuration due to the different number of coils to be attached to one supporting member. Therefore, in the explanation of the present embodiment, the same reference numerals and symbols as those added to FIG. 1 to FIG. 18 are added to the same parts as those in the first to fourth embodiments, or the like, and detailed explanation will be omitted.

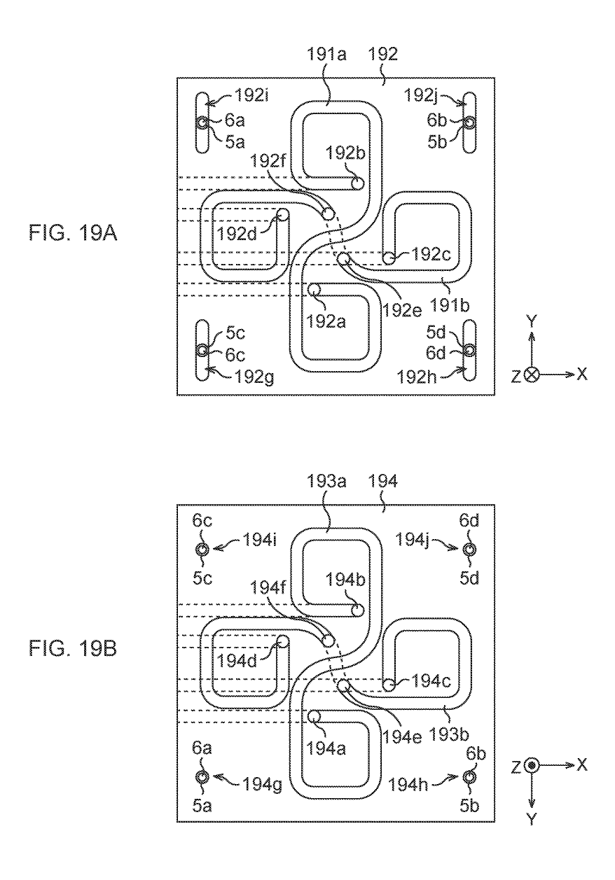

FIG. 19A is a diagram illustrating one example of a configuration of first coils 191a, 191b, and a first supporting member 192. FIG. 19B is a diagram illustrating one example of a configuration of second coils 193a, 193b, and a second supporting member 194.

The first coils 191a, 191b are arranged on and fixed to the first supporting member 192 in a state where center portions of coil surfaces thereof (portions in a figure of 8) are mutually overlapped and their coil surfaces are displaced by exactly 90[°]. Specifically, the first coils 191a, 191b are arranged and fixed at positions being 4-fold symmetry in which an axis passing through a center of the first supporting member 192 and perpendicular to a plate surface of the first supporting member 192 is set as an axis of symmetry.

Similarly, the second coils 193a, 193b are arranged on and fixed to the second supporting member 194 in a state where center portions of coil surfaces thereof (portions in a figure of 8) are mutually overlapped and their coil surfaces are displaced by exactly 90[°]. Specifically, the first coils 193a, 193b are arranged and fixed at positions being 4-fold symmetry in which an axis passing through a center of the second supporting member 194 and perpendicular to a plate surface of the second supporting member 194 is set as an axis of symmetry.

Further, as explained in the first embodiment and the like, it is designed such that when the first coils 191a, 191b and the first supporting member 192 are arranged, the coil surfaces of the first coils 191a, 191b and the second coils 193a, 193b (the plate surfaces of the first supporting member 192 and the second supporting member 194) become parallel in a state where the first coils 191a, 191b and the second coils 193a, 193b have the interval G therebetween. The interval G may be constant or variable.

On the first supporting member 192, holes 192a, 192b intended for attaching the first coil 191a to the first supporting member 192 are formed, and holes 192c, 192d, 192e, 192f intended for attaching the first coil 191b to the first supporting member 192 are formed. The holes 192e, 192f are formed for the purpose of arranging a portion of the first coil 191b overlapped with the first coil 191a on a surface on a side opposite to the surface illustrated in FIG. 19A, in order to prevent the first coils 191a, 191b from interfering with each other on the surface illustrated in FIG. 19A. Further, in the example illustrated in FIG. 19A, moving holes 192g to 192j for moving the first supporting member 192 in parallel in order to adjust the inductance value of the reactor, are formed on the first supporting member 192. The moving holes 192g to 192j play roles same as those of the moving holes 121a to 121d illustrated in FIG. 12A and FIG. 12B.

On the second supporting member 194, holes 194a, 194b intended for attaching the second coil 193a to the second supporting member 194 are formed, and holes 194c, 194d, 194e, 194f intended for attaching the second coil 193b to the second supporting member 194 are formed. The holes 194e, 194f are formed for the purpose of making a portion of the second coil 193b overlapped with the second coil 193a position on a surface on a side opposite to the surface illustrated in FIG. 19B, in order to prevent the second coils 193a, 193b from interfering with each other on the surface illustrated in FIG. 19B. Further, on the second supporting member 194, holes 194g to 194j intended for attaching the second coils 193a, 193b to the second supporting member 194 are formed. The holes 194g to 194j play roles same as those of the holes 4a to 4d illustrated in FIG. 2B.

As described above, an effect similar to that of the first embodiment can be achieved even when the plural coils 191a, 191b are attached to one supporting member (the first supporting member 192), and the plural coils 193a, 193b are attached to one supporting member (the second supporting member 194). Besides, by designing as above, it is possible to further widen the adjustment range of the inductance value of the reactor.

### Modified Example

In the present embodiment, the explanation has been made by citing the case where the first coils 191a, 191b, and the second coils 193a, 193b are arranged by being displaced by 90[°], respectively, as an example. However, each of the number of first coils and the number of second coils may be three or more. The number of first coils is set to N, and the number of second coils is set to N (N is an integer of 2 or more). Angles at which the N pieces of coils are arranged are set to be in a state of being displaced by 90/(N/2) [°]. When it is designed as above, the combined inductance GL obtained by the N pieces of first coils and the N pieces of second coils can be added and subtracted or adjusted based on the theory of the adjustment of the combined inductance GL explained while referring to FIG. 4.

Further, in the present embodiment, the explanation has been made by citing the case where the first supporting member 192 to which the plural first coils 191a, 191b are attached is moved in parallel, as an example. However, it is also possible to rotate the first supporting member to which the plural first coils are attached, as explained in the first embodiment. Further, as explained in the third embodiment, it is also possible that the first supporting member to which the plural first coils are attached performs both of the rotation and the parallel movement. Further, also in the present embodiment, the various modified examples explained in the first to fourth embodiments can be employed. Note that all of the first coils 191a, 191b, and the second coils 193a, 193b may be connected in series or connected in parallel, and it is also possible that a part of the first coils 191a, 191b, and the second coils 193a, 193b is connected in series and another part thereof is connected in parallel.

### EXAMPLES

Next, examples will be explained.

### Example 1

In the present example, the reactor in the first example of the fourth embodiment was used.

The shapes of the first coil 151 and the second coil 152 are the shapes illustrated in FIG. 15. Regarding each of the first circumferential portion 151a and the second circumferential portion 151b of the first coil 151, the length in the long side direction was set to 400 [mm] and the length in the short side direction was set to 200 [mm]. Regarding each of the third circumferential portion 152a and the fourth circumferential portion 152b of the second coil 152, the length in the long side direction was set to 400 [mm] and the length in the short side direction was set to 200 [mm].

One made by passing a Litz wire of 45 sq through a hose was set as each of the first coil 151 and the second coil 152. The first coil 151 and the second coil 152 are the same. The first coil 151 and the second coil 152 were connected in series.

The first coil 151 was rotated relative to the second coil 152 while fixing the second coil 152, and the rotation angle of the first coil 151 was adjusted. In states where the first coil 151 was held at respective rotation angles, a high-frequency current of 20 [kHz] and 1000 [A] was applied to the first coil 151 and the second coil 152, and the combined inductance GL and the power loss of the reactor were measured.

It was confirmed that when the first coil 151 is rotated relative to the second coil 152 while fixing the second coil 152, the combined inductance GL is changed, and by adjusting the rotation angle of the first coil 151, it is possible to finely adjust the inductance.

The state where the combined inductance GL becomes the minimum value at the time of rotating the first coil 151 relative to the second coil 152 while fixing the second coil 152, was obtained when the first circumferential portion 151a of the first coil 151 and the fourth circumferential portion 152b of the second coil 152 are mutually overlapped and the second circumferential portion 151b of the first coil 151 and the third circumferential portion 152a of the second coil 152 are mutually overlapped (refer to the state illustrated in the top diagram of FIG. 4). In this case, the inductance value of the reactor was 4.0 [μH], and the power loss of the reactor was 8.1 [kW].

On the other hand, the state where the combined inductance GL becomes the maximum value at the time of rotating the first coil 151 relative to the second coil 152 while fixing the second coil 152, was obtained when the first circumferential portion 151a of the first coil 151 and the third circumferential portion 152a of the second coil 152 are mutually overlapped and the second circumferential portion 151b of the first coil 151 and the fourth circumferential portion 152b of the second coil 152 are mutually overlapped (refer to the state illustrated in the bottom diagram of FIG. 4). In this case, the inductance value of the reactor was 13.5 [μH]. Further, the power loss of the reactor was 8.0 [kW], which was not different almost at all from the power loss when the combined inductance GL becomes the minimum value.

Based on the results of the verification test described in the example 1, it was possible to confirm that the inductance value of the manufactured and assembled reactor can be easily and accurately adjusted to the target value. Further, conventionally, when designing and manufacturing reactors in which specifications regarding inductance are different to be three types of 5 [μH], 8 [μH], and 12 [μH], for example, it has been required to design and manufacture three different reactors, and then adjust the manufactured reactors. On the contrary, in the present example, it was confirmed that only by designing and manufacturing one reactor, it is possible to realize the reactor satisfying different specifications of 5 [μH], 8 [μH], and 12 [μH], respectively, through adjustment at the time of shipment, and thus it is possible to greatly reduce costs in the designing and manufacturing steps.

Note that it was confirmed that also when the first coil 151 and the second coil 152 in the first example of the fourth embodiment are applied to the supporting member 121 of the second embodiment illustrated in FIG. 12A and FIG. 12B, and the first coil 151 is moved in parallel relative to the second coil 152 while fixing the second coil 152, the combined inductance GL is changed, and by adjusting the movement amount of the first coil 151, it is possible to finely adjust the inductance.

### Example 2

In the present example, there was produced a reactor in which the number of turns of each of the first coils 191a, 191b and the second coils 193a, 193b of the fifth embodiment is set to five turns, and the first coils 191a, 191b can be rotated in a state of fixing the second coils 193a, 193b. The shapes of the first coils and the second coils are the shapes illustrated in FIG. 19A and FIG. 19B (note that the shapes of the first coils and the second coils are set to flat spiral shapes).

The length of each of the circumferential portions (the first circumferential portion, the second circumferential portion, the third circumferential portion, and the fourth circumferential portion) of the first coils and the second coils was set to 400 [mm].

Further, one made by passing a Litz wire of 45 sq through a hose was set as each of the first coils and the second coils. The first coils 191a, 191b and the second coils 193a, 193b are the same. All of the coils were connected in series.

The first coils were rotated relative to the second coils to adjust the position of the first coils to the position at which the combined inductance GL becomes the maximum value, and the first coils were fixed at that position. To the reactor configured as above, a high-frequency current of 20 [kHz] and 500 [A] was applied.

The inductance of the reactor was measured, and it took one hour to adjust the position of the first coils. The maximum value of the combined inductance GL was 51.5 [μH], and the power loss of the reactor was 7.2 [kW].

According to accomplishments achieved by the present inventors, when newly manufacturing, in a high frequency reactor including a core described in Patent Literature 2, a reactor satisfying a specification of 20 [kHz], 500 [A], and 50 [μH], similar to the specification of the reactor of the present example, the reactor is manufactured, an energization test is conducted, the measurement of inductance is performed, and then the inductance of the reactor is adjusted to the target value. For this reason, it has been required to perform a step in which the device is disassembled once to adjust a gap of core, and then the device is assembled again, the energization test is conducted, and the inductance is measured again.

Even in a case where the disassembling and the reassembling of the reactor are finished by only one additional time, it has been necessary to perform a step requiring a minimum period of one day. On the contrary, in the present example, after the manufacture of the reactor, the inductance of the reactor can be adjusted to the target value in one hour as described above, and thus the effect of cost cutting because of the great reduction in the step of adjusting the inductance of the reactor, was confirmed.

Note that the above-explained embodiments and examples of the present invention each merely illustrate a concrete example of implementing the present invention, and the technical scope of the present invention is not to be construed in a restrictive manner by these. That is, the present invention may be implemented in various forms without departing from the technical spirit or main features thereof.

### INDUSTRIAL APPLICABILITY

The present invention can be utilized for an electric circuit having an inductive load, and so on.

1. A reactor capable of varying an inductance as a constant of an electric circuit, the reactor comprising:
a first coil having a first circumferential portion, a second circumferential portion, and a first connecting portion;
a second coil having a third circumferential portion, a fourth circumferential portion, and a second connecting portion;
a first supporting member supporting the first coil;
a second supporting member supporting the second coil; and
a holding member holding the first coil and the second coil, wherein:
the first circumferential portion, the second circumferential portion, the third circumferential portion, and the fourth circumferential portion each are a portion circling so as to surround an inner region thereof;
the first connecting portion is a portion that connects one end of the first circumferential portion and one end of the second circumferential portion mutually;
the second connecting portion is a portion that connects one end of the third circumferential portion and one end of the fourth circumferential portion mutually;
the first coil and the second coil are connected in series or parallel;
the first circumferential portion and the second circumferential portion exist on the same plane;
the third circumferential portion and the fourth circumferential portion exist on the same plane;
a set of the first circumferential portion and the second circumferential portion and a set of the third circumferential portion and the fourth circumferential portion are arranged in a parallel state with an interval provided therebetween;
both or one of the first coil and the second coil performs both or one of a rotation about an axis of the first coil and the second coil as a rotation axis and a parallel movement in a direction perpendicular to the axis;
the axis is an axis passing through a middle position between a center of the first circumferential portion and a center of the second circumferential portion and a middle position between a center of the third circumferential portion and a center of the fourth circumferential portion; and
the holding member is made of one or a plurality of members and it makes the set of the first circumferential portion and the second circumferential portion and the set of the third circumferential portion and the fourth circumferential portion become parallel with the interval provided therebetween and prevents the first coil and the second coil after performing both or one of the rotation and the parallel movement from moving.

2. The reactor according to claim 1, wherein:
moving holes are formed on both or one of the first supporting member and the second supporting member;
the holding member is inserted in the moving holes;
the moving holes have sizes and shapes capable of making the holding member inserted in the moving holes move in a direction parallel to a surface perpendicular to the axis; and
the both or one of the first supporting member and the second supporting member moves when the holding member inserted in the moving holes moves.

3. The reactor according to claim 2, wherein:
a plurality of moving holes are formed on both or one of the first supporting member and the second supporting member;
a shape of each of the plurality moving holes is an arc shape; and
the both or one of the first supporting member and the second supporting member rotates when the holding member inserted in the moving holes moves.

4. The reactor according to any one of claims 1 to 3, wherein:
when both or one of the first coil and the second coil rotates in a stepless manner, both of a first state and a second state can be created;
the first state is a state in which the first coil and the second coil are mutually overlapped to make directions of magnetic fields generated from the first coil and the second coil to be mutually the same; and
the second state is a state in which the first coil and the second coil are mutually overlapped to make the directions of the magnetic fields generated from the first coil and the second coil to be mutually opposite.

5. The reactor according to any one of claims 1 to 3, wherein
both or one of the first coil and the second coil can perform both of the rotation and the parallel movement.

6. The reactor according to any one of claims 1 to 3, wherein
shapes and sizes of the first circumferential portion, the second circumferential portion, the third circumferential portion, and the fourth circumferential portion are the same in a portion of 60[%] or more of the total length of the first circumferential portion, the second circumferential portion, the third circumferential portion, and the fourth circumferential portion.

7. The reactor according to any one of claims 1 to 3, wherein:
directions of magnetic fields generated from the first circumferential portion and the second circumferential portion are mutually opposite directions; and
directions of magnetic fields generated from the third circumferential portion and the fourth circumferential portion are mutually opposite directions.

8. The reactor according to any one of claims 1 to 3, wherein
the number of turns of each of the first coil and the second coil is two or more.

9. The reactor according to any one of claims 1 to 3, wherein:
there are a plurality of the first coils and a plurality of the second coils; and
the plurality of the first coils and the plurality of the second coils are connected in series or parallel.

10. The reactor according to any one of claims 1 to 3, wherein
each of the first supporting member, the second supporting member, and the holding member has an insulating property and a non-magnetic property.
